(19) United States
(12) Patent Application Publication
(10) Pub. No.: US 2003/0097640 A1
(43) Pub. Date: May 22, 2003

(54) System and method for creating and editing documents

(75) Inventors: Steven B. Abrams, New City, NY (US); Ralph E. Bellofatto, Ridgefield, CT (US); Robert Mack Fuhrer, New York, NY (US); Daniel Vincent Oppenheim, Croton on Hudson, NY (US); James Lawton Wright, Chappaqua, NY (US); Richard Charles Boulanger, Somerset, MA (US); Neil Leonard III, Jamaica Plain, MA (US); David Stefan Mash, Framingham, MA (US); Michael Rendish, North Sandwich, NH (US); Joseph Charles Smith, Framingham, MA (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/201,914

(22) Filed: Jul. 25, 2002

Related U.S. Application Data
(60) Provisional application No. 60/307,364, filed on Jul. 25, 2001.

(51) Int. Cl. G06F 15/00

(52) U.S. Cl. 715/530; 715/501.1

(57) ABSTRACT

A system for creating and editing documents may include a reference view function which allows a user to quickly and easily refer to data that may not be included in a document. The inventive system may also include a function for saving and restoring view configurations to ensure that valuable ideas may be stored and recalled, and/or a function for tracking of motivic re-use of data.

### CROSS REFERENCES TO RELATED APPLICATIONS

This Application claims the benefit of U.S. Provisional Application No. 60/307,364 which was filed on Jul. 25, 2001 by Steven Abrams, et al. and assigned to the present assignee, and which is incorporated herein by reference.

### BACKGROUND OF THE INVENTION

1. Field of the Invention

The present invention relates generally to a system and method for creating and editing documents, and more particularly, a system and method for creating and editing documents that are the product of creative endeavors, characterized by a capturing much data, organizing it visually, and fluidly moving between editing tasks. Such documents include, for example, textual documents, pictures, and musical compositions.

2. Description of the Related Art

Conventional data processing systems (e.g. software systems) for creating and editing various forms of documents are typically focused on editing the resulting artifact, not supporting the creative work of conceiving and developing ideas. The latter requires support for gathering large amounts of data, bringing it together for viewing, considering, and manipulating, and laying it out in a flexible ways, similarly to the ways in which creative practitioners—i.e. graphics designers, music composers, etc.—lay out items on their work desk. In practice, these and other practitioners juxtapose among the items brought in for consideration are various tools, placed in specific locations to support specific tasks. Further, many of these creative tasks are “motivic” in nature, with much re-use of material, altered for various purposes, but re-used nonetheless. Conventional systems do not provide adequate support for data-processing analogs of these (and other) real-world creative practices, and as such, fall short of supporting these activities to their fullest potential.

For example, conventional data processing systems allow users to share and re-use data. OLE® and Opendoc®, for example, allow both the embedding by copy of data from one type of application into a document primarily for another application (e.g., embedding a spreadsheet in a word processing document), as well as embedding that data by reference (e.g., including a link to another spreadsheet file within a word processing document). In both of these cases, however, the embedded data is actually a part of the document. That is, the word processing document, when edited, displayed, and printed, actually contains the spreadsheet. Although to perform certain edit operations on that copied data, a conventional system typically knows to launch another application (e.g., through an ActiveX control), the data is certainly part of the document. This allows the construction of compound documents containing more than one kind of data (e.g., text and spreadsheet data in the same document), as well as the “live” re-use of data (e.g., linking to a spreadsheet so that changes to the spreadsheet are automatically reflected in the document).

In addition, conventional systems permit the linkage of data across documents through a construct known as a “hyperlink” which attributes referential properties to some piece of content in the document to facilitate navigation to that linked data (i.e. hyperlinks in a web page). However, a person creating a document often refers to other information (e.g., other data) which is neither a part of the document nor hyperlinked from a part of the document. For example, a person composing a musical composition often refers to other scores or melodies which are not a part of the musical composition on which he is working. However, conventional systems for creating document, such as systems for composing music, do not allow a user to record these sorts of references to other information to support instantaneous referral at the point of interest to the creator. Further, in many software applications, there are many windows, tool bars, and other components that can be opened, closed, and positioned. For example, Adobe Photoshop® has a one window for each image being edited, plus windows for a “history” view, a tool bar, a layer selector, etc. Microsoft Word® has toolbars for formatting paragraphs and characters, charts, common operations such as opening and closing files, etc. Visual C++ has windows that show the program stack, watches for variables, and other things that can facilitate debugging.

The inventors have observed that when using such software applications, users often work in a task-directed manner. When focusing on a particular task users often arrange the tools required for that task in a convenient way, perform the task at hand, and then move the windows and tools in a manner convenient for the next task. When users need to revisit the previous task, they reposition the windows.

However, there is no mechanism for easily restoring any previously used window layout in that manner. Some systems (e.g., Logic Audio®) do provide a mechanism for manually saving a screen “preset” of the window layout, however there are several limitations. Manually setting up presets can be tedious. In addition, there is a limited (generally small) number of presets available. Further, the user has no visible means for remembering what window layout is associated with a given preset. Thus, conventional systems provide a cumbersome way of managing display screens, for example, during a creative process.

Further, creators (e.g., music composers, authors, etc.) often re-use pieces of content in different places within a work. For example, a key phrase may be used several times in a document, or a given software idiom may be used within a program, or a musical phrase or motive may be re-used in a composition. Notably, in each of these examples, the creator may alter the content for each appearance, so the motives are not precise copies. Instead, they are first copied and then changed, using current tools.

However, to the creator, the multiple uses of the content are all instances of the same idea. Because the creator changes the content in each use, the “link” feature of many of these tools is inappropriate, since through this feature, altering linked content will either change it in all places, or force the creator to break the link. Alternatively, the creator can use the simple copy-and-paste features of most tools.

However, conventional systems do not represent for the user the fact that there is a relationship among these multiple uses of content. This is important, for example, to facilitate queries of the form, “Where are all places that this idea was re-used?” and Where did I get this idea from?”

### SUMMARY OF THE INVENTION

In view of the foregoing problems of the conventional techniques, an object of the present invention is to provide a system for creating and editing documents.

The inventive system includes a memory device and processor. The memory device may store software for associating hypernote data with a point-of-reference in the document, the hypernote data being separately stored from the point-of-reference in the document. The processor may use the software to generate a view of the document, the view of said document including a view of the hypernote data associated with the point-of-reference in the document.

The view of the document may also include a view of the document including the point-of-reference, and the hypernote data may be visually related to the point-of-reference in the view of the document. In addition, the view of the hypernote data may be displayed in a read-only manner. Further, the view of the hypernote data may include a pinned view which appears visually anchored to an anchor point in the document related to said point-of-reference, and the pinned view moves with the document as the user scrolls through the document. Furthermore, the view of the hypernote data may include a floating view which appears visually unanchored to the document and remains in a fixed location on the screen as a user scrolls through the document.

In addition, the hypernote data comprises data from a source external to said document. Further, the hypernote data may include data from the document, the data having a source location in the document which is different from the point-of-reference.

In one example, the inventive system may include a memory device for storing software for representing and displaying the document, a processor for using the software to generate a view of the document, and a display device for displaying the view of the document, the view of the document including a window to show data related to the document, the window including a visual characteristic (e.g., a beveled edge) which indicates a property of the data displayed in the window.

For example, a beveled edge may indicate that the data displayed in the window includes hypernote data, or that the view of the document includes a pinned view and/or a floating view.

Further, the document may include a musical composition, a word processing document, a picture (e.g., photographic) document, or a spreadsheet document. Similarly, hypernote data may include textual data, image data, musical data, tabular data, and/or hypertext markup language (HTML) data.

Further, hypernote data may be implemented as a bundle which refers to other content.

In another example, the inventive system may include a means for representing a point-of-reference in said document, a means for representing the hypernote data associated with the point-of-reference in the document, and a means for identifying that the hypernote data is incorporated by reference and not included in the document at the point-of-reference. The system may also include a means for displaying the hypernote data so as to visually identify it as hypernote data, and a means for selectively ignoring hypernote data during final output preparation.

The present invention also includes an inventive method for creating and editing documents. The inventive method includes associating hypernote data with a point-of-reference in the document, the hypernote data being separately stored from the point-of-reference in the document, and generating a view of the document, the view of the document including a view of the hypernote data associated with the point-of-reference in the document..

In another aspect, the memory device store software which automatically tracks a window configuration, and the processor may access the software, for identifying a stable window configuration and, prior to responding to a user request to change from the stable window configuration, recording a state of the window configuration in the memory device.

The present invention may also include a method for creating and editing documents which includes automatically tracking a window configuration, identifying a stable window configuration, and prior to responding to a user request to change from the stable window configuration, recording a state of the window configuration in the memory device.

In another aspect, the memory device may store software which automatically tracks window configurations, and the processor may access the software, for identifying a relevant window event, determining if a predetermined time has elapsed before a next relevant window event and, if so, recording the state of the window configuration in the memory device.

In another aspect, the inventive system includes a display screen for displaying at least one window configuration, each window configuration shown as a graphical image, each graphical image being associated with a set of data structures containing data necessary to restore a window configuration, a selector for allowing a user to select a window configuration, and a processor for obtaining a set of data structures associated with a selected window configuration, and restoring the selected window configuration on the display device.

Further, the present invention may include an inventive method for creating and editing documents which includes displaying at least one window configuration, each window configuration shown as a graphical image, each graphical image being associated with a set of data structures containing data necessary to restore a window configuration, selecting a window configuration, obtaining a set of data structures associated with a selected window configuration, and restoring the selected window configuration.

In another aspect, the memory device may store software for automatically tracking copies of data used in the document, and the processor may access the software to create a record of copying of content, the record indicating from where the data was copied, and to where the data was copied. For example, the record may be stored in an ancestry tree data structure including a tree node which is a reference to content in a document, the tree node including a child link which indicates that a copy was made of the content from a content location referred to by said tree node, to a content location referred to by the child node. Further, the processor may automatically maintain the ancestry tree data structure whenever content is selected and copied. The system may also include a display device for displaying, in a graphical form, links of an ancestry tree superimposed over an overview of the document.

Further, the data may include musical fragments and the document may include a musical composition. In addition, the data may include textual content and the document may include a text document.

Further, the present invention includes a method for creating and editing documents which includes automatically tracking copies of data used in the document, and creating a record of copying of content, the record indicating from where the data was copied, and to where the data was copied.

The present invention may also include a method for creating and editing documents which includes storing an ancestry tree data-structure wherein a tree node is a reference to content in a document, and a child link of a tree indicates that a copy was made of said content from a content location referred to by a parent node, to a content location referred to by a child node, and accessing the ancestry tree data-structure in order to automatically track a re-use of materials in the document.

In another aspect, the inventive system for creating and editing documents includes an input device (e.g., a keyboard, MIDI device, mouse, etc.), and a monitoring system for monitoring (e.g., automatically) the input device and capturing (e.g., automatically) input presented to peripherals, without requiring a user instruction. The system may also include an annotation device for annotating captured input with contextual information about a system state at a time of capture, the information including, for example, calendar date, wall-clock time, and/or current scroll position in the document. The system may also include a storage facility for storing captured data, and/or a search mechanism for retrieving captured data based on a property of a system state at a time that the input was captured. Further, the property comprises one of a time/date captured, and a current document position when captured.

With its unique and novel features, the present invention provides better support for creative tasks, giving a user a tool that help track his workflow and allow him flexibility in what information he sees while working. Specifically, the present invention supports a compositional workflow by helping a user (e.g., music composer) to capture ideas, to organize those ideas to focus on the essential aspects, to manipulate those ideas in intuitive ways, and helping the user to keep track of his state-of-mind as he shifts from one activity to another.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 illustrates an inventive system 100 for creating and editing a document according to the present invention;

FIG. 2 illustrates a flowchart 200 for creative workflow which may be implemented in one exemplary embodiment of the inventive system 100 according to the present invention;

FIG. 3 illustrates a display screen 200 containing an idea space and project space according to the present invention;

FIG. 4 illustrates a database palette (query mode) display screen 400 according to the present invention;

FIGS. 5A-5B illustrate sample pseudo-code that may be used to identify pinned bundles and to render the content residing in a given bundle, according to the present invention;

FIG. 6 illustrates a display screen 600 containing a workspace configuration log according to the present invention;

FIG. 7 illustrates an ancestry links display screen 700 according to the present invention;

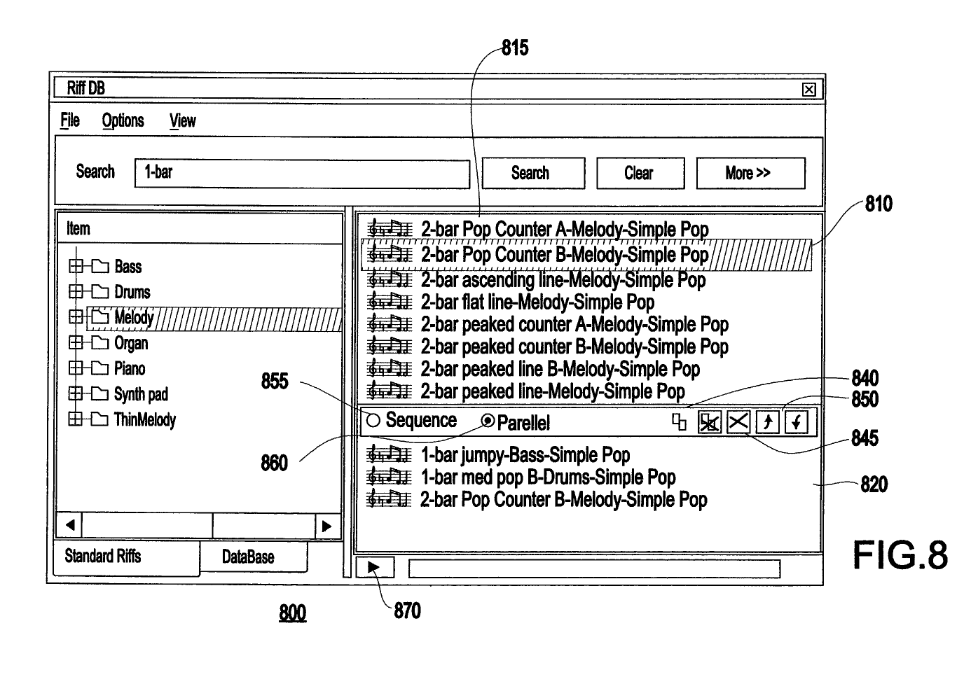

FIG. 8 illustrates a database palette (riff assembly area) display screen 800 according to the present invention;

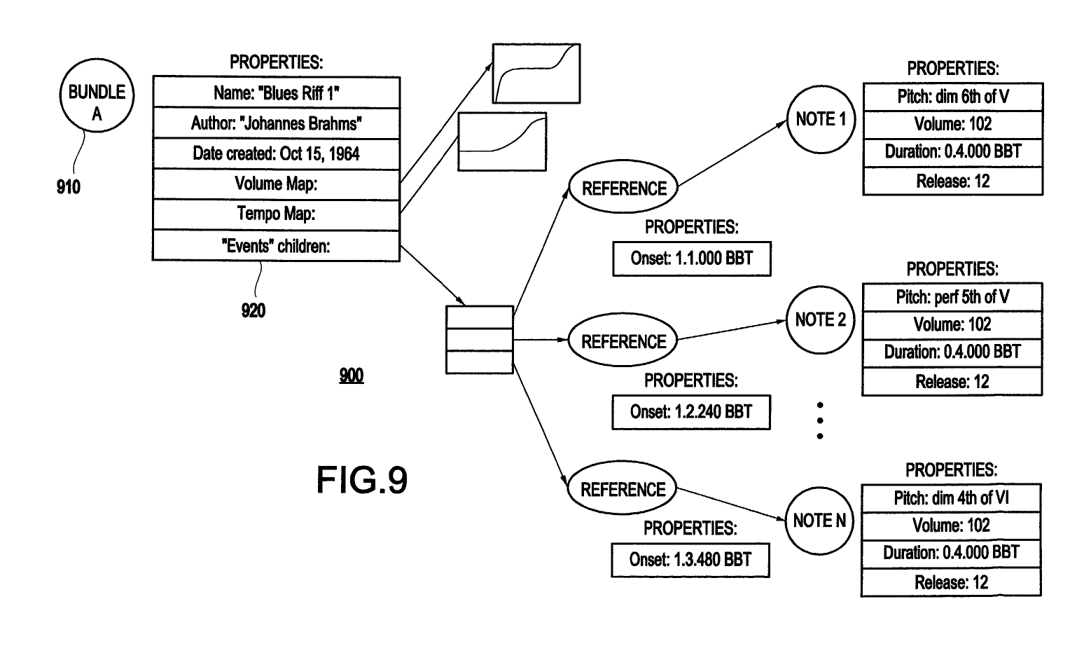

FIG. 9 is a flowchart 900 illustrating how properties may be used in a small compositional structure, according to the present invention;

FIG. 10 is a hierarchical map 1000 that illustrates the use of links in a creative (e.g., compositional) structure, according to the present invention;

FIG. 11 is a flowchart illustrating a first mechanism 1100 for determining when a view configuration may be saved in the inventive system 100;

FIG. 12 is a flowchart illustrating a second mechanism 1200 for determining when a view configuration may be saved in the inventive system 100;

FIGS. 13A illustrates the basic structure of a bundle and its cloned offspring, FIG. 13B is a flowchart illustrating the process of cloning of bundles and FIGS. 13C-13D are flowcharts illustrating how two functions for tracing ancestry may be implemented according to the present invention;

FIGS. 14A-14C are flowcharts illustrating inventive methods 1400, 1450 and 1470 for creating and editing documents, respectively, according the present invention;

FIG. 15 illustrates a typical hardware configuration 1500 which may be used for implementing the inventive system 100 and method 1400, according to the present invention; and

FIG. 16 illustrates a programmable storage medium 1600 which may be used to store instructions in the inventive system 100 and method 1400 according the present invention.

### DETAILED DESCRIPTION OF PREFERRED EMBODIMENTS OF THE INVENTION

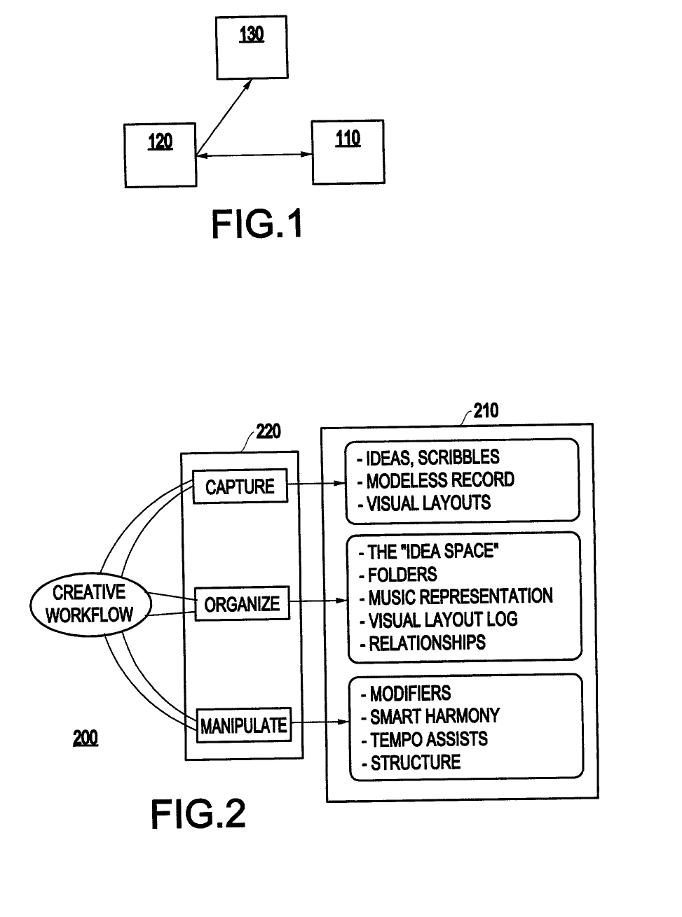

Referring now to the drawings, FIG. 1 illustrates a system 100 for creating documents.

As shown in FIG. 1, the inventive system 100 for creating and editing a document includes a memory device 110 and a processor 120. For example, the memory device 110 may store software for associating hypernote data with a point-of-reference in the document. The hypernote data may be separately stored from said point-of-reference in said document. The memory device (e.g., RAM, ROM, etc.) may include, for example, a plurality of memory devices which may or may not be remotely located and indirectly connected via a network such as the internet.

The processor 120 may use the software stored in the memory device to generate a view of the document. Specifically, the view of the document includes a view of the hypernote data associated with the point-of-reference in the document. The system 100 may also include a display device 130 connected to the processor for displaying a view of the document.

It should be noted that the term “document” used herein should not be construed as limited to a text document. Specifically, the term “document” may include any work-product, or artifact capable of being enhanced by the present invention. For example, such work-product or artifact may include a computer program, e-mail, and photograph (e.g., picture).

It should also be noted here that the term “hypernote data” should be construed to include any information, objects, data etc. that may be viewed on the display device 130, but which is not necessarily included in the document being viewed. For instance, hypernote data may be located within the document or stored in a different location (e.g., in a different memory device, or in a different logical unit or file in the same memory device) from the document.

The inventive system may also include an input device such as a keyboard (e.g., a MIDI keyboard) or mouse for allowing a user to quickly and easily input data (e.g., information, objects, data etc.) into the inventive system 100. For instance, a user may use the input device to input a musical composition into the system which is stored in the memory device or a database, accessible by the processor.

The inventive system 100 may include at least three functions. First, the inventive system 100 may provide for reference views (e.g., embedded views, pinned views, and floating views) which allow a user to quickly and easily refer to data that is not included in a document. Second, the inventive system 100 may provide for saving and restoring view configurations to ensure that valuable ideas may be stored and recalled. And third, the inventive system 100 may provide for tracking of motivic re-use of data. A motivation for all three functions (i.e., motivic re-use, view configuration logging, and pinned views) is to provide the better support for creative tasks, giving a user a tool that help track his workflow and allow him flexibility in what information he sees while working.

I. Overview: Creative Workflow

A. Capture, Organize, Manipulate

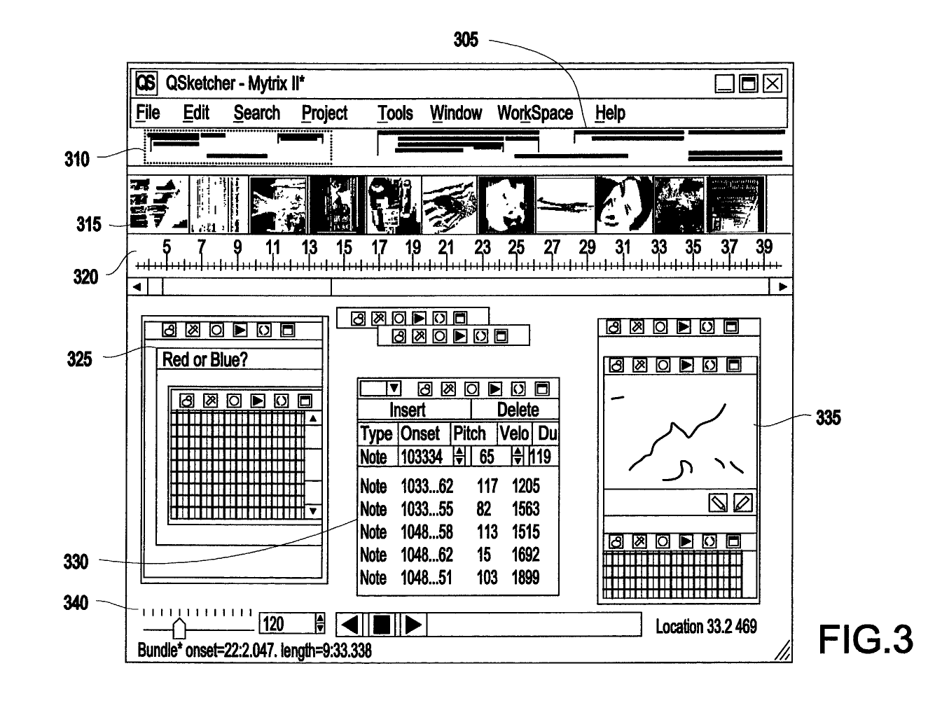

FIG. 2 provides a flowchart 200 illustrating the creative workflow concept underlying one exemplary embodiment the inventive system 100. Specifically, FIG. 2 illustrates an example of a creative workflow as it may apply to creating or editing a musical composition.

As shown in FIG. 2, the inventive system 100 may allow the composer to manage 220 (e.g., capture, organize and manipulate) various components 210 (e.g., capture ideas, scribbles, modules record, visual layout; organize the “Idea Space”, folders, music representation, visual layout log, and relationships; and manipulate modifiers, smart harmony, tempo assists and structure) to support the early stages of the creative workflow, from idea conception through realization, rather than the mere order and synchronization of musical fragments with film.

More specifically, the inventive system 100 may include a free-form ‘idea space’, a main workspace that can be configured to individual needs, an “idea capturing” facility, a workflow tracking mechanism through which previous workspace states can be examined and restored, and the ability to create a variety of relationships among musical elements.

The inventive system, therefore, allows users (e.g., composers) to move fluidly between dichotomous modes (inspiration/perspiration, capture/manipulate, and macro/micro editing levels), while directly supporting a variety of common compositional concepts, so that creators can work using the terms in which they think.

Interestingly, these dichotomous modes are also present in a wide variety of creative tasks (e.g., writing, drawing, preparing presentations) as well as more technically-oriented activities such as software design and development, architecture, and even the act of research itself. Indeed, the inventive system 100 is applicable in at least any one of these areas, not just in the area of musical composition.

The inventors' research revealed that there are three system features which composers feel are important for tool support: the ability to quickly capture musical ideas, organize those ideas in a useful manner, and manipulate them in musically meaningful ways. It is clear that a composer's workflow would be much more fluid in a system which made it trivially easy to input their ideas—as graphical sketches or scribbles, textual annotations, music played on a keyboard, and so on. Any break in the flow (e.g., to enter record mode or handle other technicalities of operating the system) could disrupt their creativity, and an idea might be lost. Ideally, every idea should be captured, and capturing should be allowed at any stage in the creative process. To support this, the inventive system 100 includes features such as the “Infinite TakeVault” and an integrated freehand drawing tool, both of which are described later.

With every musical idea captured, the inventive system 100 also prevents information overload. This may be accomplished in the inventive system 100 by providing intuitive and powerful mechanisms for organizing ideas, relating ideas to the relevant music or film content, and searching for ideas. The inventive system 100 supports these goals with features such as an integrated content palette (e.g., a database allowing a user to search materials by many criteria), and the ability to organize ideas alongside musical materials using the visual layout of windows.

The inventive system 100 also provides meaningful ways to manipulate content, thereby allowing the user to rapidly explore the musical space, experiment with ideas, and develop and structure musical fragments into a final work. To this end, the inventive system 100 supports high-level structural manipulations as well as precise low-level editing.

B. Cognitive Facets Affecting System Effectiveness

The inventors' research also revealed cognitive facets 230 (e.g., pervasive higher-level issues) that have great impact on the system's effectiveness in each of the above areas: conceptual orientation, context, state, and relationships.

Context relates to the creator's mental state while working on a particular problem. For example, composers often cover their desk or walls with sketches of musical ideas, outlines of musical sections, fragments of music and motifs, photographs of objects relating to their work, notes about intent, scripts, cue lists, “to do” notes, napkin scribbles and the like. These objects help the composer mentally work out various relationships and musical processes that are an important part of musical creativity. Writers, graphics designers, and other creative workers often work similarly. In conventional systems, however, the computer and monitor hold only a small portion of the working environment.

The inventive system 100, on the other hand, allows the user to capture much more of the working environment “inside the computer.” This allows the computer to do far more than in conventional systems, such as track relationships between materials and tasks, capture ideas along with the rich context in which they were created, support a much smoother flow between different tasks, and quickly recreate different versions of the environment according to the needs at hand.

While one may not expect to model the cognitive facets of these relationships directly, it should be recognized that the visual layout of objects in the composer's workspace often reflects important aspects of his thought process. The inventors, therefore, developed a user interface that allows the user to place anything anywhere, creating what may be considered a visual layout. To assist in recovering the mental context as it relates to a given problem, layouts are remembered and easily recalled within the inventive system 100.

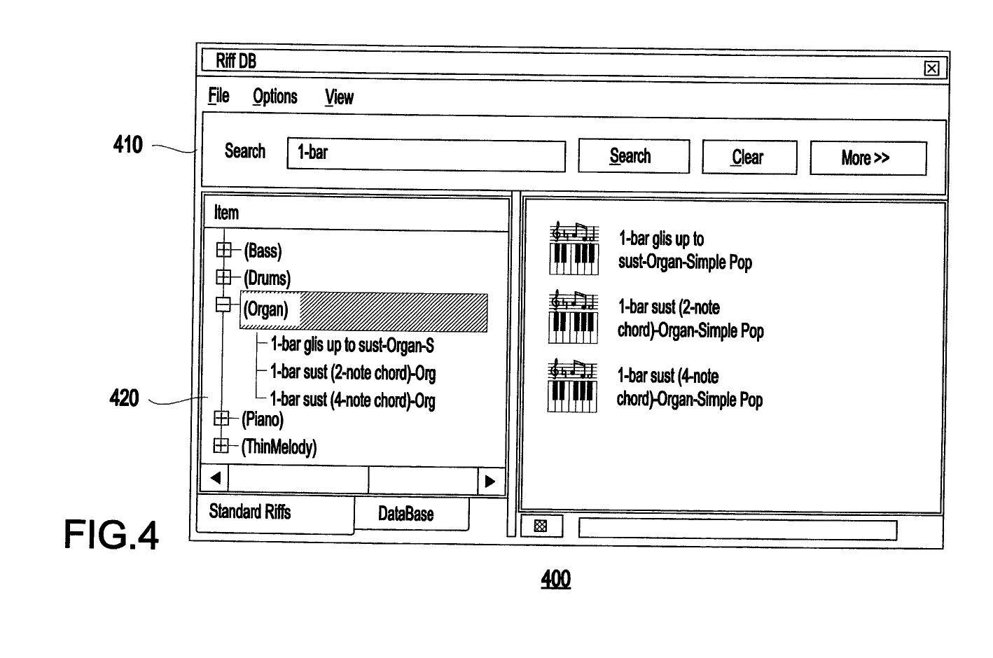

These ideas are central to the design of the idea space 305 which is included in the display 300 in FIG. 3 which may be generated using the inventive system 100. As shown in FIG. 3, the idea space 305 in this view includes a nested block view with nested pianoroll view. The exemplary display 300 also includes project space music schematic 310, a “You are here” frame 315 (which may be dragged to scroll or zoom), a key frame view 320, a time line and scroll bar 325, an event list view 330, a nested block with scribble and pianoroll views 335 and tempo and transport control bar 340.

The notion of relationships arose because creators (e.g., music composers) mentally relate various materials within a composition in a number of ways. Composers often find it useful to visualize these relationships so that one could view the musical materials in relationship to some compositional process, and not only by the order in which they appear in the composition timeline. To facilitate this, the inventive system 100 provides a function for tracking motivic re-use of data which is described in detail below.

II. The Working Environment

A. The Workspace

The design of the working environment (e.g., composition environment) in the inventive system 100 is rooted in several simple observations. Balancing opposites is a way of life for creators: inspiration vs. perspiration, toplevel structure and form vs. minute details, sketching vs. refining. Creators have many different work-styles: no single approach or process is sufficient. The workplaces of creative people are generally littered with meaningful arrangements of stuff.

Further, to accommodate widely varying work-styles, the tools and environment should be both flexible and easy to customize. This is often much more important than the sheer power of each tool. That is, if a power tool is hard to use, discover, or access when wanted, the tool gives little benefit. And it is important to have tools that work at each of the various levels, for example, fine editing tools as well as gross or structural manipulation tools.

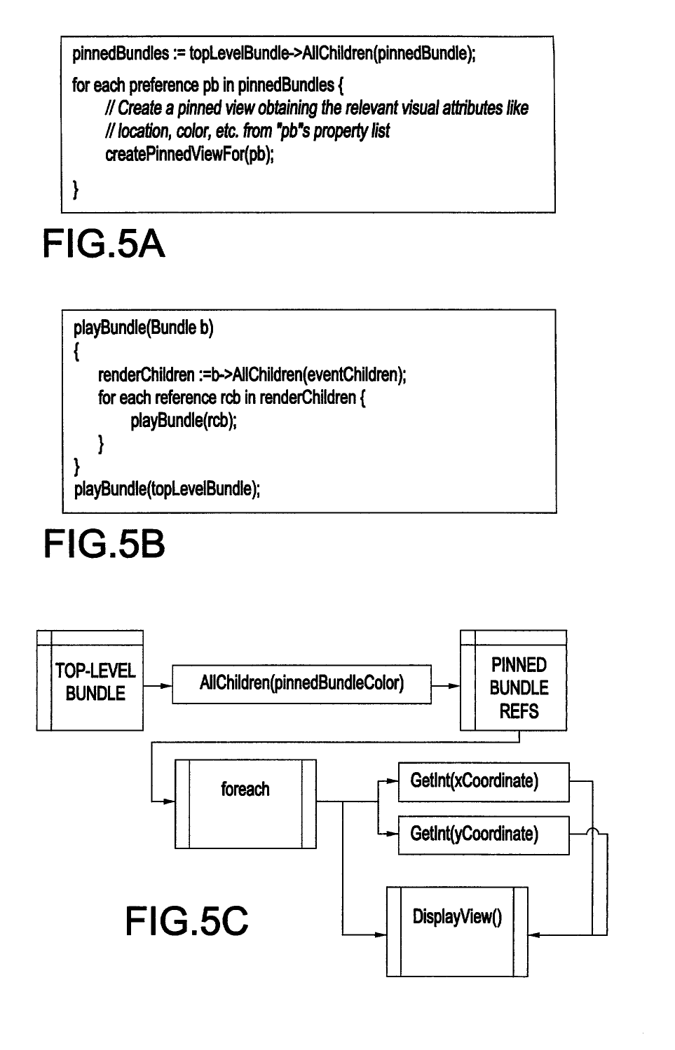

Therefore, as shown in FIGS. 3 and 4, the visual environment of the Inventive system 100 may be divided into roughly three parts: the Project Space 305, the Idea Space 325 and the Database Palette 400. The Project Space 305 manages project-level information, activities and navigation. This includes foldable schematics of the music and visual structure (which can be very different), as well as more traditional high-level film context (e.g., overall timeline, important time markers, and video ‘key frames’).

The Idea Space 325 provides the project's main “work surface”. The Idea Space 325 may be characterized as a “boundless sheet of paper”, in which time runs from left to right. Content of all forms (e.g., music, post-it notes, scribbles, control curves, and compound assemblies) is captured, displayed and manipulated on this work surface, in a user-defined arrangement of nested views. Some of this content is playable. Other content is simply presented for reference. The Idea Space 325 is also used for managing the project's hierarchical structure.

The Database Palette 400 holds all kinds of materials including, for example, raw materials, finished sections and quick sketches (e.g., essentially any system object including cue sheets and phone logs, tool configurations and visual layouts). The Database Palette 400 also includes facilities for browsing or searching through content.

The inventive system 100, therefore, provides several ways of presenting data (e.g., music or non-music related content) in a document. For example, a musical entity may be viewed as a block-oriented structural view, as a “piano roll” event display, as a textual event list, as expressive curves (e.g., tempo, pitch, volume), or even as sketches and textual annotations. Any or all of these views may be displayed simultaneously. The inventive system 100 also affords the user considerable flexibility in arranging these views so as to display exactly what the composer needs to see, where and when he wants to see it. For example, most views can occupy very small amounts of screen space, by adjusting the amount of information displayed, facilitating the transition from macro to micro level work.

The inventive system 100 is designed to help a creator (e.g., music composer) visualize his mental context in several ways. The Project Space 305 visually presents the global creative (e.g., compositional) structure as a compact “Music Schematic,” showing, for example, the top 1 to 3 levels of the content hierarchy. A separate “Film Schematic” presents the global structure of the film, showing the structural counterpoint between film and score. A highlighted rectangle (i.e., the “You-Are-Here” block 310 in FIG. 3) shows the portion of the composition currently visible in the Idea Space 325. This “You-are-Here” block 310 can be manipulated directly to effect scrolling and zooming. The vertical dimension in the IdeaSpace 325 can be used for any purpose.

B. Embedded Views, Pinned Views, and Floating Views

In the inventive system 100, three kinds of view modes (Embedded, Pinned and Floating) clearly distinguish between project content seen “in time”, context-sensitive expanded and referential views of content, and free-standing tools and palettes. This allows the inventive system 100 to provide a novel mechanism for viewing and correlating content in or out of temporal context. In general, the invention clearly distinguishes between data that is part of the document, displayed at its appropriate location in the document, and views of data anchored to a point-of-reference within the document, where the data is sourced from some other location—either another location in the document, or another document entirely.

In a representative embodiment for music composition, as shown in FIG. 3, a content view typically appears within the Idea Space 325 so that the left side of the view rectangle indicates the content's onset, while the rectangle's width indicates the content's duration. This may commonly be referred to as an embedded view. Moving the view rectangle changes the onset of the content, and resizing the rectangle changes the content duration (e.g., by manipulating tempo, changing a loop or repeat factor, or perhaps clipping the beginning or end of the content). In short, changes to embedded views directly affect the composition (and appear immediately in the Music Schematic). Moreover, the contents of an embedded view are tied to the indicated point on the film's timeline and are rendered at the specified time relative to the containing section.

However, it is often desirable to view a piece of music content out of context. For instance, it may be desirable to examine a section near the start of the composition while working on similar material in another section, or to expand a view for detailed editing purposes. For such purposes, the present invention provides pinned views. A pinned view is in effect a duplicate view of some content that can be arbitrarily resized or moved without affecting the temporal properties of that content. Pinned views are also known as “hyperannotations”, or “hypernotes”, as they share some qualities with both hyperlinks and annotations, but are more capable than either. Pinning is not limited to ordinary musical content; it can also be applied to any form of content: text, graphical sketches, functional curves, and the like.

The term “pinned” derives from the fact that these views may be visually anchored to a specific point-of-reference (e.g., a time location) in the composition. Thus, scrolling the Idea Space 325 causes the pinned view to move, disappear and reappear just like embedded views. Unlike embedded views, however, pinned views are not rendered, for example, when the containing section (e.g., the document) is played. Indeed, pinned views act as if a composer literally pinned a copy of some content onto the score (e.g., the document), and may be collapsed to conserve space when not in use. Composers may use a pinned view, for example, to show a relationship between two pieces of content or to provide another reminder of context.

In the inventive system 100, pinned views can be implemented as Bundles (e.g., regular content entries) that refer to other content (note that the inventive system 100 supports multiple references to the same content). Specifically, pinned views can use the same kind of links as those used to indicate containment relationships, but which possess a different “link color” tag. In this arrangement, pinned views are given a link color of “pinned bundle”, while embedded bundles are given a link color of “embedded bundle”. By checking the tag on each bundle, the playback mechanism knows not to play the bundle content when it encounters a pinned view—it plays only when it sees bona fide containment of the underlying content.

A key feature of the inventive system 100 is the use of differentiated border styles/decorations (e.g., beveling) to visually distinguish embedded, pinned and floating views from one another at a glance. The graphical user interface (GUI) can use the “link color” tags placed on each Bundle as mentioned above to determine how to draw the border of the frame for that particular Bundle.

This mechanism for distinguishing a pinned view from an embedded view extends to word processing, spreadsheet, and many other application programs. Once the underlying representation is augmented to support something like the reference mechanism and an appropriate property/flag mechanism, the on-screen display routines can render the borders of such references differently to indicate a “pinned view” (e.g., “out-of-place view”) of content, and the hard-copy or final output form rendering mechanism can choose to ignore these references.

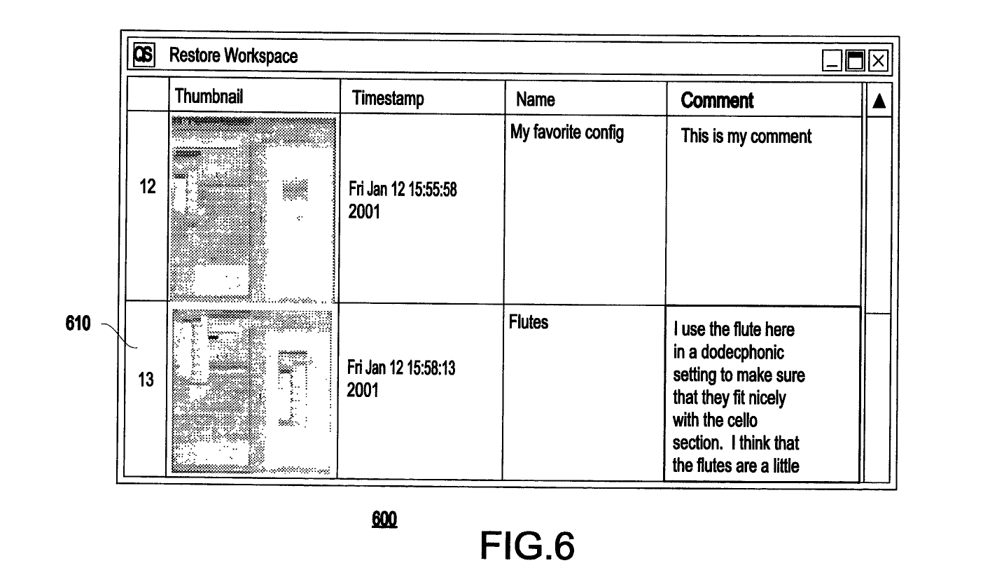

For example, when displaying a set of views on a display screen, an example of pseudo-code for identifying the pinned bundles (e.g., when displaying the pinned views on a display screen) may be as provided in FIG. 5A. Similarly, FIG. 5B provides an example of pseudo-code that may be used to render the content residing within a given bundle. It should be noted that since the rendering code in FIG. 5B does not make reference to the “pinnedBundle” children of any bundles, the pinned views (e.g., redundant pinned views) do not result in duplicated audio events. Further, a flowchart for displaying pinned views represented by bundle references is provided in FIG. 5C.

The location of a pinned view in the inventive system 100 is a property of the associated Bundle that can be used as the basis for a search query. For example, the user can ask “at what locations have I pinned a view of this contained Bundle?” This helps the user to answer the more conceptual question: “what other parts of the document might be related to this part of the document?”

In addition, the inventive system 100 may also provide for floating views. As noted above, like a pinned view, a floating view may be collapsed as needed. Modifying its geometry has no temporal consequences, and it does not get rendered when the composition is played.

However, unlike a pinned view, a floating view is not anchored to a particular project location, but rather may be considered to be, for example, fixed at a location on the screen (i.e., display screen). Thus, scrolling the IdeaSpace 325 has no effect on floating views. Instead, the floating views behave as if literally pinned onto the display screen. Since reference views can hold tools as well as musical content, this provides a very flexible means for organizing the workspace.

The above description of these views has relied on location in the temporal domain, as it has focused on content which has a temporal extent, specifically music. However, the same concepts can be applied in systems and methods for creating and editing other forms of content. In text document editors, for example, hypernotes are anchored to a point-of-reference in the text document, even though this is “out-of-place” for the data, i.e. the data are actually sourced from some other location, either within the document or within a different document altogether.

C. The Workspace Configuration Log

The creative process frequently requires shifting from one focus to another. For example, a composer may start by working on the melody, which then leads one to change the harmonic progression, which alters the harmonic rhythm, which in turn leads one to consider alternative rhythmic skeletons, and so on. An author, for example, might start off by working on an outline, continue with fleshing out details some sections, document footnotes, and so on. Each of these activities might be best carried out with a different arrangement of views and tools, and it is desirable to quickly return to arrangements of views and tools that have proven useful to a given creator in the past.

The inventive system 100 may address this need by providing simple ways for capturing and recalling a snapshot (configuration) of the set of views, including tool configurations and the portion of the composition (or the database) that was being viewed. For example, a composer can have many such snapshots available at any time for recall at the click of a button. Unlike conventional systems, it is not necessary to explicitly save a snapshot in the inventive system 100, because the system 100 automatically captures a snapshot whenever it detects stability in the window configurations. That is, the inventive system 100 may examine all window systems events and set a timer whenever a change to the window configuration occurs. If the timer expires before another change occurs, it may consider the configuration to be stable. It may then take an image of the entire screen, reduces it to thumbnail size, and adds it to the workstation configuration log. This may be referred to as the “You Were There” feature.

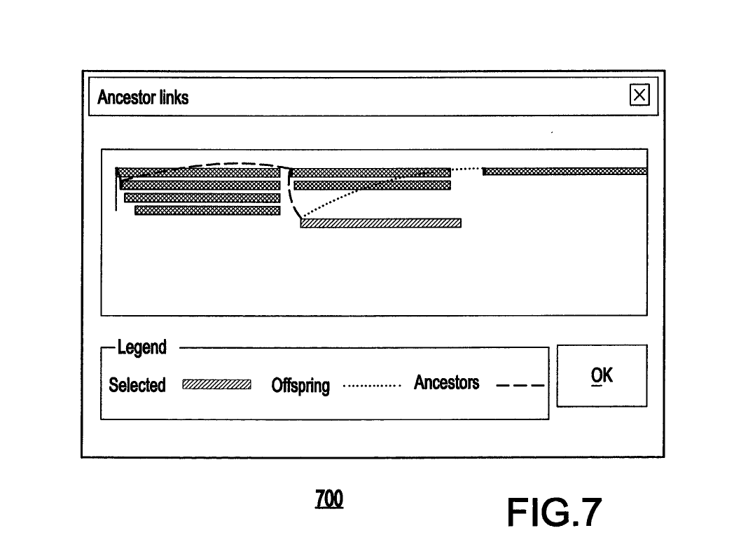

Whether captured manually or automatically, the snapshots may appear within a Workspace Configuration Log, as illustrated in the display screen 600 in FIG. 6. Each snapshot is represented by a thumbnail graphic of the display screen layout along with the wall-clock time and project time position when it was captured. Comment and title fields are provided for optional annotations by composers. The log may be sorted by any field. Further, the workspace configuration may be restored, for example, by clicking on the restore button 610.

By deriving all GUI components from a common base class (e.g., Qconfigurable) the inventive system 100 is able to consolidate the implementation of the restoration of these snapshots. The QConfigurable class adds the support for reporting and changing parameters such as size, position, content, and view locus.

III. Managing Components

a. Capture

Ideas come in many forms, at any time, particularly in the early stages of a composition. Moreover, their usefulness is often not obvious a priori, but rather, typically becomes evident only later. Unfortunately, ideas are also evanescent, disappearing if one takes too long to capture them.

Therefore, the inventive system 100 may incorporate several important principles. For example, no idea should ever be lost. All captured content may be stored, for example, in an “infinite take vault.” Content may also be annotated automatically to preserve its original context. In addition, the inventive system 100 supports many kinds of content, including several that are not by nature musical, in order to capture the user's ideas, regardless of form. This is based on the notion that the value of an idea does not rest solely on its functional interaction with other parts of the document. Indeed, some entities never have a functional effect on the document content, but nevertheless serve a critical role in the development process.

Thus, in the inventive system 100, hand sketches, graphics clips (e.g. still frames extracted from video), audio clips (e.g. music or recorded conversations), textual annotations, musical fragments, and skeletal compositional elements (e.g. A-B-A structures), all participate in the creative process. The inventive system 100 captures each of these forms of ideas, and allows the user to place them in the Idea Space 325, serving many possible uses, such as fragments, improvisations, or musical sketches leading to the final work, visual cues of compositional intent, placeholders for future work, and several perspectives on the same musical entity.

To increase the likelihood of not losing any of the user's ideas, the inventive system 100 provides modeless or near-modeless capture on all of the various input peripheral devices (MIDI keyboard, mouse, QWERTY keyboard graphic tablet and so on), which removes the burden of planning the capture of ideas, as well as the distraction of manipulating the controls of multiple capture facilities in order to enter capture mode on the appropriate input device. As a result, the inventive system 100 facilitates concurrent user activities and “constructive noodling” (e.g., unplanned improvisation) better than other existing systems.

Furthermore, the capture mechanisms in the inventive system 100 provide a fluidity that few conventional systems offer, by virtue of both the “boundless paper” metaphor and their near-modeless behavior. Thus, a user of the inventive system 100 can watch a film (e.g., for which music is being composed) while, for example, sketching in the Idea Space 325, playing on the MIDI keyboard, typing notes, etc.. The system captures the ideas, along with relevant contextual information. For example, to record from a MIDI keyboard, one simply begins playing without explicitly entering “record mode”. The system actively monitors the MIDI ports at all times and records everything played. The recorded material is stored in the database's “take vault” folder, and annotated with creation attributes including the wall clock time and project location. If the Idea Space 325 has an active insert locus, the new material is also inserted as a new block at that location.

By extension, to sketch a tempo curve using the inventive system 100, a user may simply begin drawing on a block's background using a mouse or other input device. Similarly, to create a post-it note, one may simply begin typing. Any ambiguity (e.g., in interpreting gestures, or determining whether the user wants to draw a shape, create a selection, or move an object) may be resolved by the choice of input device.

For instance, the MIDI keyboard may be used as a recording device, a graphics tablet may be used for freehand drawing and gestural control (Wright, M., Wessel, D., Freed, A., “New Musical Control Structures from Standard Gestural Controllers”, Proceedings of the ICMC, Thessaloniki, Greece, 1997) and the mouse may be used for selection and direct manipulation of data or objects.

IV. Data Representation

Clearly, a representation (i.e. a set of data structures) that directly models the key concepts makes implementing all of the above easier. The music representation in the inventive system 100 is essentially a best-of-breed design, incorporating those features that facilitated support of composer-requested features (e.g., Dannenberg, R. 1993. “Music Representation Issues, Techniques and Systems”, Computer Music Journal, 17(3) (Fall 1993) provides an excellent overview of music representation issues).

Considering the requirements of capturing all forms of ideas and organizing them in a common environment, the representation in the inventive system 100 is based on a small number of general concepts. For instance, in the inventive system 100, all materials (e.g., textual notes, modifiers, phrases, motives, graphical sketches) are bundles, and are stored and manipulated in the same ways. This flexibility allows the database to store different kinds of content, allows reference views (e.g., pinned views and floating views) of anything to be placed anywhere, and so on. In fact, database folders are also bundles. Certain bundles (e.g., MusicBundles) are specially marked packages (i.e., derived classes that add accelerator methods for common properties (e.g. Note's GetPitch( )) and provide semantically-important processing beyond raw property access (e.g. Note::GetPitch( ) can take modifiers and context into account in computing the pitch).

At the heart of the present invention's music representation is a free-form mostly-hierarchical structure of bundles. The inventive system 100 does not force track-oriented, notation-oriented, MIDI-specific or other overly constraining models on the music (although the system is capable of representing all of these possibilities). This permits the creation of skeletal compositional structures, and is a natural match for the free-form blank-sheet-of-paper paradigm of the IdeaSpace 325. This is an important component of the inventive system's ability to support a fluid work style in the early phases of the composition process.

Further, every bundle and note may be a property bag, i.e., an association of symbols (interned strings) with properties. All musical data and meta-data are represented by properties. Valid property types include strings, symbols, numbers, booleans, pitches, temporal locations/durations, instrument descriptors, expressive curves, time-sorted event lists, wall-clock timestamps, images and references.

In addition, any client can add properties to a bundle. This feature allows the composer and the various tools to add both functional data and arbitrary annotations to bundles as well as to folders in the Database Palette 400. The current implementation is reasonably time-efficient and space-efficient.

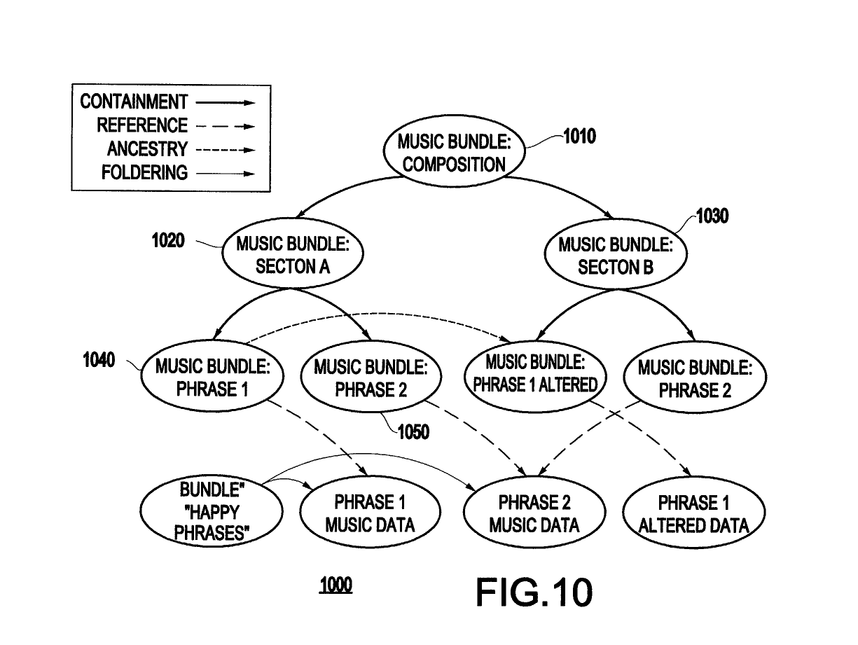

FIG. 9, for example, is a flowchart 900 illustrating how properties may be used in a small compositional structure in the inventive system 100. For instance, the properties of Bundle A 910 may include a name (Blues Riff 1), an author (Johannes Brahms), a date created (Oct. 15, 1964) and other Properties.

Further, properties can be “inherited” by child bundles from parent bundles, and overridden if desired. For example, a child can inherit or override tempo from its parent. Modifiers may also be inherited, and provide a powerful, high-level mechanism for altering and shaping content in child bundles from enclosing contexts. For example, as shown in FIG. 9, Bundle A 910 may include three “Events” children 920 having various properties.

In addition, colored links may be used to represent all of the various relationships among bundles. For example, parent/child relationships in event lists are represented using links of event color, user-defined database folders' contents are indicated with links of folder color, and the ancestry of copies is recorded using ancestry-colored links. Any client can add links of arbitrary colors, and navigate the content using these links. The search mechanism in fact uses the same code to scan through database folders that it uses to scan through the composition hierarchy.

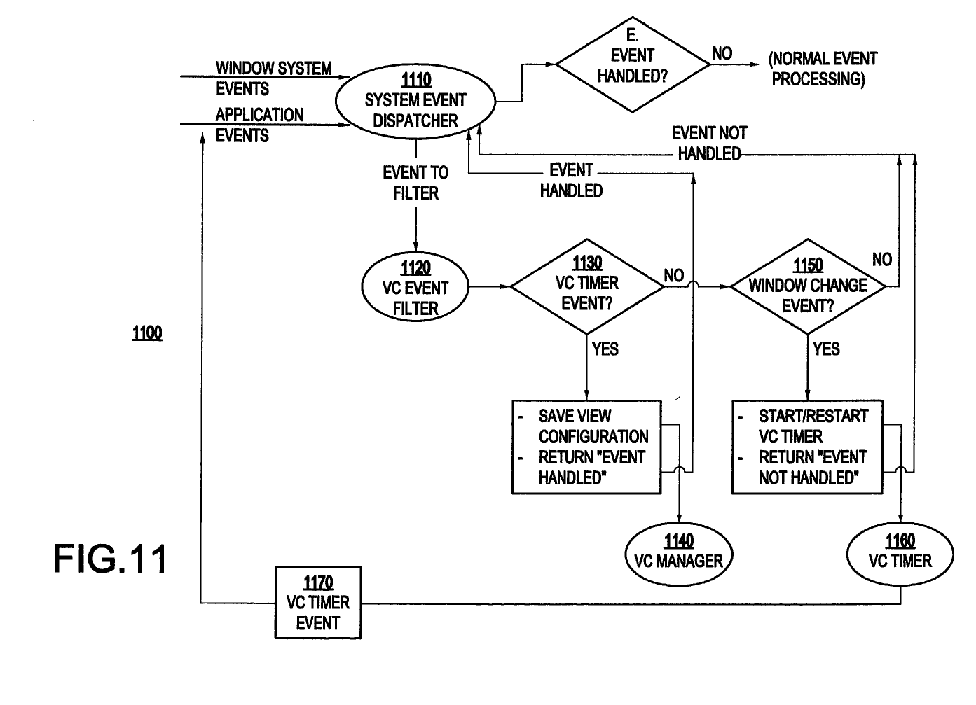

FIG. 10, for example, is a hierarchical map 1000 that illustrates the use of links in a compositional structure. As shown in FIG. 10, the music bundle (composition) 1010 contains music bundle (section A) 1020 and music bundle (section B) 1030. In addition, music bundle (section A) 1020 contains music bundle (phrase 1) 1040 and music bundle (phrase 2) 1050, and so on.

A bundle in the hierarchy can be a reference to a shared musical entity, such as a motivic riff or melody. References are themselves property bags and can, therefore, augment or override properties of the shared content. This was originally designed to support motivic reuse, while retaining the possibility of customizing each reuse. For instance, as shown in the hierarchical map 1000 in FIG. 10, a shared bundle's content (e.g., music bundle (phrase 2) 1050 is shared by music bundle (section A) 1020 and music bundle (section B) 1030) could be interpreted within two distinct harmonic contexts (or tempo maps) provided by two different parents. However, the inventors found that copy-to-modify was sufficient, given the ability to trace the ancestry of copies. Therefore, the present invention does not expose shared references in the user interface.

The music representation is easily instrumented with the present invention's pitch representation (Abrams, S., Fuhrer, R., Oppenheim, D., Pazel, D., Wright, J. 2000, “A Framework for Representing and Manipulating Tonal Music.” Proceedings of the ICMC, Berlin, Germany), which embodies a basic model of Western tonal music. This supports smart transpositions, harmonic transformations, and melodic shaping, while preserving functional aspects of harmony. Expressive curves or “modifiers” (Abrams, S., Fuhrer, R., Oppenheim, D., Pazel, D., Wright, J. 2000, “A Framework for Representing and Manipulating Tonal Music.” Proceedings of the ICMC, Berlin, Germany) can be used to modulate any numeric parameter, such as pitch, volume, onset, duration, or tempo. These curves are an important part of the conceptual framework of the present invention.

Further, the inventive system 100 supports several different types of time: bar/beat/tick, Standard Motion Picture Time Encoding (SMPTE), microseconds, and audio samples. A note's onset, for example, can be specified in any form of time that is defined within its context, i.e., within the enclosing bundles. This ability is key to describing, for example, musical content with a metric structure (bars/beats/ticks), locked to specific SMPTE frames within the film, a composer's core functional requirement. As a further illustration, a bundle with a metric structure can hold a note whose onset lies on a particular frame, to align the note with a particular film event, regardless of tempo changes. Compound representations such as bar/beat/tick can house a mixture of positive and negative quantities, allowing, for example, the expression of 50 ticks before beat 2 of bar 3.

Music representation objects may also issue notifications to interested clients (e.g., the user interface) for relevant events. For example, property bags (e.g., notes and proper bundles) may issue notifications as property values change. Since event lists are properties, adding and deleting children uses this mechanism to keep clients updated.

It should be noted that while the above discussion on a representation has focused on music, and has several properties specific to music, it's basic structure is well-suited to a wide variety of content, including text, images, and other forms of content. Essentially, a representation may be a network of containers, connected by different kinds of links. Each container can hold arbitrary data, and each container has associated with it properties that indicate the spatial or temporal relationship between the contents of that container and its “parent” container. This, or any other content-neutral containment representation, permits the invention to be applied to a wide variety of content types.

V. Saving and Restoring View Configurations

The inventive system 100 may also include a function for saving and recalling window (e.g., display screen) configurations.

Specifically, the inventive system 100 may include a memory device for storing software for automatically tracking a window configuration, and a processor accessing the software, for identifying a stable window configuration and (e.g., prior to responding to a user request to change from the stable window configuration) recording a state of the window configuration in the memory device.

More specifically, the inventive system 100 may automatically determine when a window configuration should be saved by monitoring the users actions and recognizing when a user is satisfied with a window configuration. The inventive system 100, therefore, provides a means for the user to browse saved window configurations, and to restore any selected configuration.

In particular, the inventive system 100 may automatically identify when the user has stabilized a window and tool configuration and begun to focus on a specific task. The system 100 may, thus, automatically save the window configuration, and easily restore the window and tool configurations to facilitate returning to a task (or for performing related tasks), all in conjunction with a mechanism for describing the contents of a preset.

Specifically, the function for saving and recalling (e.g., automatically saving and recalling) window configurations (e.g., changes in a window configuration) may include identifying layout configurations by “thumbnail” snapshots, along with some descriptive text, timestamps, etc. (e.g., using a display device), allowing the user to choose one of these layout configurations (e.g., using a selector), and reconfiguring (e.g., automatically reconfiguring) the windows in the system 100 to closely correspond to the layout shown in the thumbnail snapshot.

A “layout configuration” in this context may be defined as an arrangement of windows (including views and editors) on the data in a model. The qualifier “closely correspond” may be needed because it may not be possible to exactly return to the given layout, as the underlying data may have changed in such a way as to make portions of the layout meaningless or impossible (e.g., a view on deleted content).

The layout configuration may include, in a simple case, the types of editors and their positions on the screens. In a more full-featured case, it may also include the bounds of data viewed in each window (i.e. which portion of a document is viewed).

Optionally, the system may include a mechanism for automatically identifying when the user has stabilized a window and tool configuration and begun to focus on a specific task. The system can now automatically save the window configuration.

Unlike conventional systems, with the inventive system 100 it is not necessary to explicitly save a snapshot. The inventive system 100 automatically captures a snapshot whenever it detects stability in the window configurations. The system 100 examines all window systems events and sets a timer whenever a change to the window configuration occurs. If the timer expires before another change occurs, it considers the configuration to be stable. It then takes an image of the entire screen, reduces it to thumbnail size, and adds it to the workstation configuration log.

This is a method for tracking the changes that a user has made to the position of windows in a system. In a typical embodiment, the invention hooks into the event loop of the application, where it can detect configuration changes. After detecting a period of configuration stability, it then takes a snapshot of the configuration. The snapshot is both an actual snapshot (i.e. a reduced image of the screen) of the relevant windows, plus a record of their types, positions, the data associated with them, etc.

In conjunction with the configuration log above, the inventive system 100 may provide an automatic “enhanced back-button” type of functionality, allowing the user to automatically back up to previous view configurations. The features disclosed can be embodied as part of a particular application where it controls the layout of the windows and tools specific to that application. In addition, they can be part of a windowing system in a computer operating system, where they can control the layout of all windows and tool of all applications in the system.

A. Determining Whether a View Configuration Should be Saved

1. First Mechanism

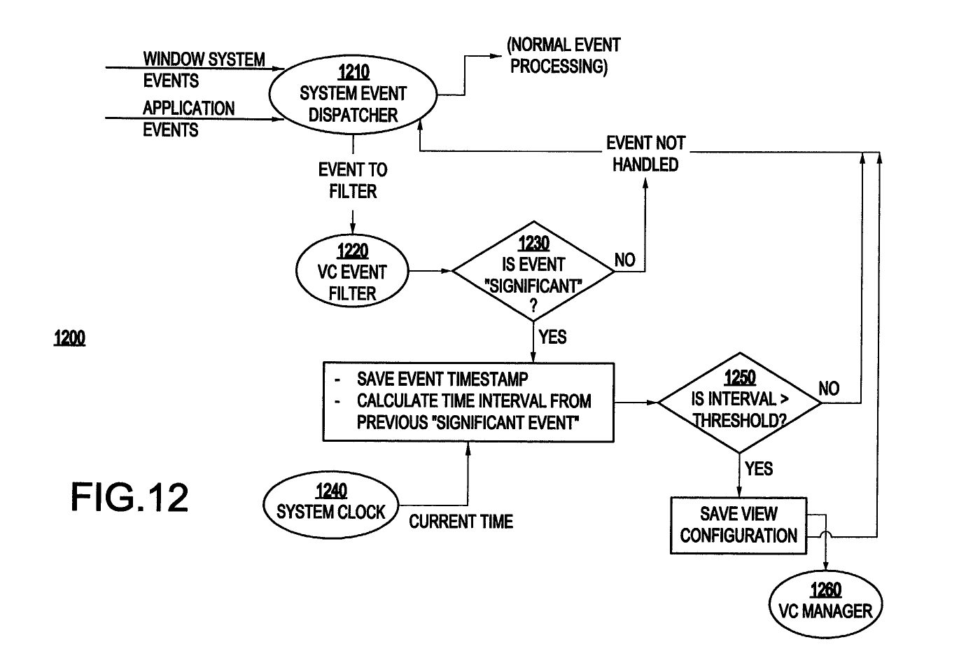

FIG. 11 illustrates a first mechanism 1100 for determining when a view configuration should be saved in the inventive system 100. Item 1110 is a system-level event dispatcher typical to all event-driven user interfaces, sometimes called a “message loop” or “message pump”, which routes or handles events according to their type or class. Item 1120 is a view configuration (VC) event filter connected to the event dispatcher 1110 in such a way that the filter 1120 processes each event received by the dispatcher 1110 before the dispatcher 1110 dispatches that event for normal processing. It is assumed that the dispatcher 1110 provides a facility for attaching event filters (e.g., mechanisms for handling events in advance of normal processing), or that the dispatcher 1110 can be modified in order to provide such a facility.

Note that an event filter 1120 returns a status code indicating whether or not it has handled a given event. If an event is marked as “handled”, no further processing is done by the system-level event dispatcher 1110.

The VC event filter 1120 implements two tests. Item 1130 is a test which checks whether or not the event is a VC timer event. If so, event filter 1120 may request the view configuration manager 1140 to save the current view configuration and then return an “Event Handled” status code to the system event dispatcher 1110. No further event processing occurs.

If the test 1130 returns false, in item 1150, another test checks whether or not the event is a Window Change event. A Window Change event is any event which moves, resizes or otherwise affects the visible appearance or function of one or more windows or user interface elements. If the event is a Window Change event, event filter 1120 starts or restarts the View Configuration timer 1160. This causes the timer 1160 to begin counting down from a preset initial value. This value may be set to any convenient interval, but is typically in the range of 10 to 20 seconds. Regardless of the outcome of test at item 1150, the event filter then returns an “Event Not Handled” status code to the system event dispatcher 1110, which then processes the event in the normal manner.

Timer 1160 is a one-shot timer which, when started or restarted, counts down to 0, emits a VC Timer event 1170 and then disables itself. The VC Timer event 1170 is then processed by the system event dispatcher 1110 and the VC event filter 1120 as described above.

2. Second Mechanism

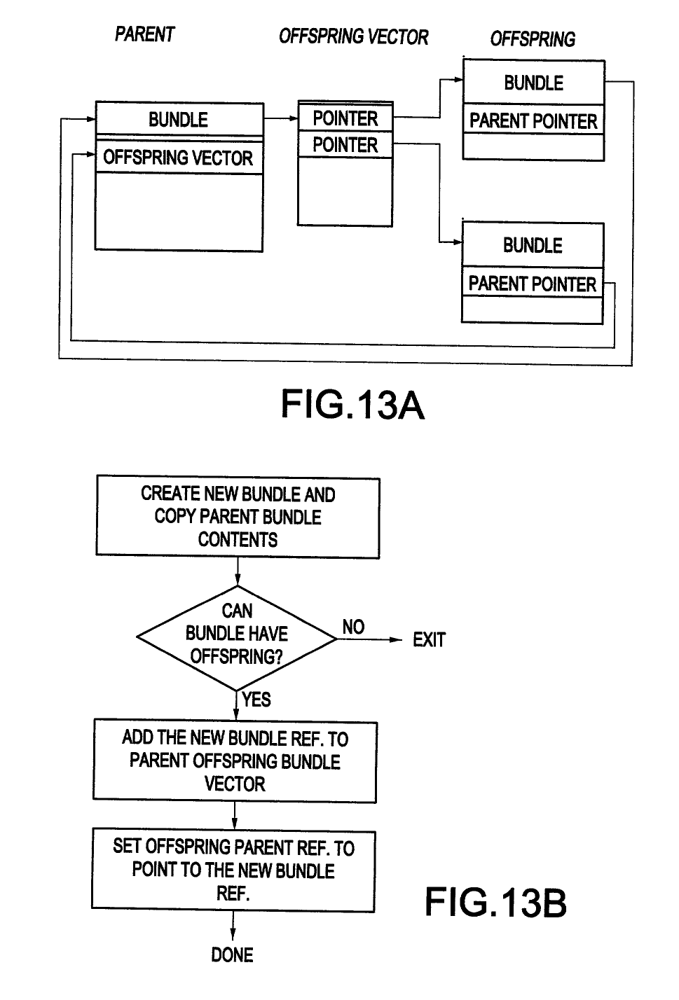

FIG. 12 shows a second mechanism 1200 for determining when a View Configuration should be saved. In this mechanism, no countdown timer is used; instead, the mechanism uses the time interval between “significant” events to determine whether a new View Configuration should be saved.

Similarly to the first mechanism 1100, item 1210 is a system-level event dispatcher typical to all event-driven user interfaces, sometimes called a “message loop” or “message pump”, which routes or handles events according to their type or class. Item 1220 is an event filter connected to dispatcher 1210 in such a way that the filter 1220 processes each event received by dispatcher 1210 before dispatcher 1210 dispatches that event for normal processing. It is assumed that dispatcher 1210 provides a facility for attaching event filters (mechanisms for handling events in advance of normal processing), or that the dispatcher 1210 can be modified in order to provide such a facility.

The view configuration (VC) event filter 1220 may implement two tests. The first test 1230 determines whether or not the event is a “Significant” event. A “Significant” event may be, for example, a Window Change event as discussed above, an application-specific status-, content- or location-change event (e.g. a change to the contents of a window, without changing the window size or position), or any other event deemed significant by the application designer and/or end user.

If the test 1230 determines that the event is significant, the timestamp of the event is captured (from the system clock 1240 or other suitable time source) and saved for later use. Then, the time interval between the current significant event and the previous significant event is calculated. The second event filter test 1250 then compares said time interval to a predetermined threshold value. If this time interval is greater than said threshold value, a new view configuration is saved using, for example, the view configuration manager 1260.

For instance, these calculations may be made (e.g., using a computer, microprocessor, central processing unit (CPU), etc.) according to the following algorithm:

Let currentTime=the current system time value (e.g. the timestamp of the current event)

Let previousTime=the timestamp of the immediately previous event

Let timeThreshold=the minimum time interval that must elapse before a view configuration is saved

Then,

timeInterval=currentTime−previousTime

If timeInterval>timeThreshold

Save View Configuration

Else

// no special action

Then

previousTime=currentTime (for subsequent use by test (item

1250))

Note that, in contrast to mechanism 1, the event filter 1220 in the second mechanism 1200 always returns a status code indicating that it has not handled the filtered event. This ensures that all filtered events are processed normally by the system 100 after the event filter 1220 has completed its function.

B. Saving and Restoring a View Configuration

A view configuration consists of a set of viewable content (e.g., internal data) elements, each having an associated UI element when visible. Each content element has a set of associated configuration properties, which include view properties (e.g. UI element geometry) and optionally other properties (e.g. content element location within a document or other compound content element). Further examples of such properties are given below.

In order to be saved and restored as part of a View Configuration, a viewable element must provide a means for getting and setting the values of its properties and must also be accessible to the view configuration (VC) manager (the entity responsible for coordinating the actions involved in saving or restoring a particular view configuration). A viewable element may be made known to the VC Manager through direct registration (e.g. an explicit connection between the element and the VC Manager), through a discovery process (e.g. traversing a tree of viewable elements starting from one or more well-known root points), or some combination of registration and discovery.

1. ViewConfigurations and Their Constituents

A view configuration is basically a set of property lists representing the configuration of a particular set of content elements (and/or independent application windows).

The configuration of a specific content element may be contained within a single property list. When a content element is involved in two or more configurations, an equivalent number of property lists are required. These property lists may be embedded directly within the associated content element, or may be contained within a separate entity and referenced by the associated content element.

In the inventive system 100, a VCPropertyList is an extensible set of <name,type,value> tuples which contains all properties associated with a particular content element within a particular ViewConfiguration. The <name> field of a tuple identifies the corresponding property, the <type> field identifies what kind of value is present, and the <value> field contains the actual data. The set of available property types includes many commonly-used types as well as an arbitrary-length string of bytes, allowing almost any type of value to be used. Other property representations are possible and would not change the basic nature of the invention.

The inventive system 100 may maintain three distinct property subsets within a single VCPropertyList: (1) a set of stock properties (common to all VConfigurable elements), (2) an optional set of class-specific properties (common to all instances of a particular type or class of VConfigurable elements); (3) an optional set of instance-specific properties. This allows each class of element (and optionally each individual element) to determine which properties should be saved and restored, and avoids the requirement for a central mechanism which understands the internal structure of all configurable elements.

Each content element involved in at least one ViewConfiguration maintains a VCDictionary, which holds the set of VCPropertyLists representing all configurations of that content element (other implementations are certainly possible). A VCDictionary is an ordered set of <name,VCPropertyList>pairs, typically indexed by a hash table to improve access speed. The <name> field corresponds to a particular unique ViewConfiguration identifier (see below); the <VCPropertyList> field holds the corresponding configuration data for that element.

Performance note—the VCPropertyLists could be kept separately, so that only recently-referenced VCPropertyLists are kept in memory. This would reduce the memory footprint of VConfigurable elements.

Note that the VCDictionary should not be associated with a UI element, but preferably only with a content element (or proxy element). UI elements and content elements have different lifetimes (UI elements are typically destroyed or reassigned when the corresponding content elements are hidden due to scrolling or other view changes). If the VCDictionary were associated directly with UI elements, it would only be possible to restore the configuration of those UI elements which happen to be currently visible.

2. Saving a View Configuration

In the inventive system 100, the following steps may be used to save a view configuration:

1. Create an empty ViewConfiguration and generate a unique identifier for it (e.g. text identifier, 128-bit binary GUID or other type of identifier)

2. Identify the set of all currently-visible UI elements which are either directly associated with a VConfigurable content element, or which can be identified (e.g. by window class or other characteristic) as a UI element for which a VConfigurable proxy should be created (one possible implementation is discussed below).

3. For each such UI element, ask the associated content element or proxy element to perform two actions: a) save all properties relevant to the current configuration of that element in a container (e.g. VCPropertyList) tagged with the ViewConfiguration identifier generated in step 1; and b) store a reference to itself in the ViewConfiguration created in step 1 (when content elements are organized hierarchically it may be sufficient to store references only to top-level ‘root’ elements).

On completion, the ViewConfiguration will contain a reference to every accessible content element (or proxy element) involved in the current configuration, and each such element will contain a set of properties enabling it to be restored within the context of that configuration.

3. Proxy Elements

It should be explained that Proxy elements may be needed when the ViewConfiguration is intended to include properties for arbitrary top-level windows. However, when all UI elements to be configured are contained within the application which implements the ViewConfiguration facility, proxy elements are not needed. In this case, all UI elements can directly support the VConfigurable interface.

However, it may be useful for a ViewConfiguration to save and restore arbitrary top-level windows associated with other concurrent applications. In this case, a proxy element may be needed for each such “foreign” window, in order to manage the storage and restoration of that window.

4. Loading a View Configuration

In the inventive system 100, a specific ViewConfiguration (uniquely labeled with a ViewConfiguration identifier as discussed above) may be loaded as follows:

1. Access and traverse the ViewConfiguration labeled with the given identifier

2. For each content element or proxy element contained within the View configuration: ask that element to reload and apply the properties previously saved for the given configuration. If a content element is not currently associated with a UI element (i.e. the content element is not currently visible), a new UI element should be allocated so that the visual presentation of that content element can be restored. If a proxy element is not associated with a currently running application and/or with an existing window hosted by such an application, that application should be launched if necessary and then requested to create an appropriately-configured window and reload the associated content. Such reconfiguration and reloading of “foreign” may be accomplished through a variety of platform-specific mechanisms (e.g.COM interfaces supporting scripting or scriptable objects of some kind).

5. Programming Interfaces

These functions are accomplished through the use of a Vconfigurable application programming interface. This interface could be organized in a variety of ways; the inventive system 100 may comprise three sets of methods within one C++ class definition:

A set of public methods for managing the ViewConfiguration facility

A set of public methods for accessing individual VConfigurable items

A set of internal methods for implementing different classes of VConfigurable items

6. Public Methods for Managing the ViewConfiguration Facility

The following methods are used for general management of ViewConfigurations. They are currently implemented as static public methods of the base VConfigurable class, but could easily be implemented as free-standing methods. All methods typically return true on success and false on failure (e.g. if no such ConfigID is found).

bool SaveWorkspaceConfiguration(const ConfigID& configID);

bool RestoreWorkspaceConfiguration(const ConfigID& configID);

// ConfigID is currently a string, but could easily be a // binary Identifier

The above methods save or restore a complete ViewConfiguration (a.k.a. a Workspace configuration). Implementation of these methods is discussed below.

The event filter entity used for determining when a ViewConfiguration should be saved automatically, is returned by the following:

RYWTMonitor* eventMonitor( );

As discussed above, this event filter is typically plugged into a platform- or system-specific event dispatcher loop (see FIGS. 11 and 12 and related discussion).

When restoring a particular configuration, it is often desirable to hide (render invisible) any currently-extant UI elements which are not part of the restored configuration. The following methods allow client code to control (and determine) whether or not such elements will be hidden:

void setHideIfNotConfigured(bool hide);

bool hideIfNotConfigured( );

The following method allows a particular class of VConfigurable item to specify additional properties which must be saved and restored for all instances of that class. ‘className’ identifies the particular class, while ‘propList’ is a list of strings naming the additional properties to be saved and restored.

void registerClassPropNames(string className, PropNameList propList);

7. Public Per-Instance Methods for Accessing Individual VConfigurable Items

Note that the per-instance methods belong to a content element (or proxy), and not to a UI element which may be associated with the content element or proxy. (The system should provide a means for retrieving the content element/proxy (if any) associated with an extant UI element. This might be accomplished via a dedicated method provided by all UI elements, or by accessing a named property of the UI element through a generic get/set property mechanism, or by a C++ dynamic_cast, or by various other mechanisms in common use.)

All methods typically return true on success and false on failure (e.g. if no such ConfigID or PropertyID is found).

The following methods are used for saving and restoring the specific configuration of a single item, and for determining whether an item holds a configuration matching a given identifier:

bool saveItemConfiguration(ConfigID& configID);

bool restoreItemConfiguration(ConfigID& configID);

bool hasItemConfiguration(ConfigID& configID);

// ConfigID is currently a string, but could easily be a // binary Identifier

The following methods are used for getting and setting the value of a configuration-related property:

bool setProperty (PropertyID& propID, Variant& value);

bool getProperty (PropertyID& propID, Variant& value);

// PropertyID is typically a string which identifies a given property // Variant holds various kinds of values (e.g. integer, string, // enumeration). An alternate implementation might provide different // pairs of get/set methods for different types of values.

All VConfigurable items typically implement the following properties:

| | |
|---|---|
| geometry | height, width and x-y position of the UI element |
| zPosition | the z-order position of the UI element (relative to |
| | other UI elements) |
| caption | the displayed title of the UI element (if any) |
| backgroundColor | the background color of the UI element |
| hidden | a flag indicating whether or not the UI element is |
| | hidden (invisible) |

Any VConfigurable item may elect to save and restore additional properties, using the internal methods described below.

8. Internal Methods for Implementing Different Classes of VConfigurable Items

The following methods are used for saving and restoring the configuration of an item in a class- and/or instance-specific manner:

| | |
|---|---|
| PropNameList* | stockItemPropNames( ); |
| | // returns list of properties which all items must |

// save and restore

| | |
|---|---|
| PropNameList* | classPropNames( ); |
| | // returns list of additional properties which all |

// items of a given class must save and

restore

| | |
|---|---|
| PropNameList* | instancePropNames( ); |

// returns list of additional properties which a

// specific individual item must save and

restore

PropertyList* beginSave(ConfigID& configID);

// Called to begin saving a specific configuration
// for a specific item

| | |
|---|---|
| bool | saveProps(PropertyList* propList, PropNameList* propNames); |

// called to save the named properties from the

// VConfigurable item into the provided

property

// list. Typically called three times, once for
// each PropNameList (stock, class,

instance).

| | |
|---|---|
| bool | endSave( ); |

| | |
|---|---|
| | // Called to finalize the storage of configuration |
| | // data for that item. |
| QPropertyList* | beginRestore(ConfigID& configID); |
| | // Called to begin restoring a specific |
| | // configuration for that item |
| bool | restoreProps(PropertyList* propList); |
| | // called to restore aspects of the item |

// configuration from the property list.

| | |
|---|---|
| void | endRestore( ); |
| | // Called to finalize restoration of an item |

// configuration

9. Mechanism for Identifying the Set of All Currently-Visible Configurable UI Elements

One possible implementation is described below (however, one of ordinary skill in the art would understand that other implementations are possible):

1. Identify all top-level UI elements within the current presentation space.

UI elements are typically organized in one or more hierarchal trees. A top-level UI element is an element which is not contained by any other UI element. There may be a single root (topmost) element or multiple root elements (n.b. when multiple roots are present, the overall scheme is a hetarchy rather than hierarchy). UI libraries and frameworks typically provide a means for identifying top-level UI elements

2. For each such UI element:

(a) Query the element to determine if it is associated with a VConfigurable content element, as discussed above (e.g. via a dedicated method, property access, dynamic_cast or other mechanism).

(B) If such a VConfigurable element exists, apply desired ViewConfiguration operations to said element.

3. Query the UI element (accessed in step 2 above) to determine whether it contains one or more nested UI elements (e.g. elements at a lower hierarchical level).

4. For each such nested UI element, repeat steps 2 and 3 recursively until no further nested UI elements are found.

10. Interaction with Top-Level Windows (e.g. for Independent Applications)

The basic ViewConfiguration mechanism can also be used to save and restore the configuration of some or all currently running applications. In this case, somewhat different means may be required for identifying the windows associated with such applications and saving or restoring relevant properties. For example, platform-specific mechanisms should be used (e.g. Win32 APIs for a Microsoft Windows 98®-based platform), rather than the UI library or framework mechanisms discussed above. Additional steps may be needed to identify the “Z” order of such independent top-level windows (e.g. the order in which windows are ‘stacked’ on the screen).

Further, platform- and application- specific mechanisms should preferably be used to access and modify the properties of such independent applications. On a Microsoft Windows®-based platform, this is most conveniently accomplished using some kind of COM-based interface (e.g. the MS ActiveDocument APIs, Microsoft VBScript or other application scripting facility).

Since these independent applications do not directly implement VConfigurable functionality, it is important for the ViewConfiguration facility to create a Proxy element for each such application, which is responsible for (a) interacting with the application to get or set appropriate properties using the appropriate platform-specific mechanism and (b) interacting with the ViewConfiguration facility to save and restore the relevant set of properties when a specified ViewConfiguration is saved or recalled.

11. Important Distinctions

It is important to distinguish between views on content and undo/redo of content. The ViewConfiguration restores a set of views (e.g. presentations or visualizations) related to a set of content elements, but does not alter the state of the actual content. By contrast, the undo/redo facility of a typical word processor changes content, but does not change the visual layout of windows, the set of available tools, etc. It is certainly possible to provide both ViewConfiguration and undo/redo support within a given application (and to use both facilities independently or together), but ViewConfiguration is fundamentally different from undo/redo.

It is also important to distinguish between a window and a UI element. A ViewConfiguration can include not only views on content, but tool arrangements (visual layout), tool configurations (functional settings) auxiliary UI controls or displays, input device configuration (e.g. mouse, keyboard, graphics tablet)—anything that might be presented to (or used by) the user via the user interface.

Therefore, unlike conventional systems, in the inventive system 100 it is not necessary to explicitly save a snapshot. Instead, the system 100 may automatically capture a snapshot whenever it detects stability in a window configuration. The system 100 examines all window systems events and sets a timer whenever a change to the window configuration occurs. If the timer expires before another change occurs, the system 100 considers the configuration to be stable. The system 100 then takes an image of the entire screen, reduces it to thumbnail size, and adds it to the workstation configuration log.

VI. Tracking Motivic Re-Use of Data

The inventive system 100, unlike conventional systems, represents for the user the fact that there is a relationship among these multiple uses of content. Specifically, the inventive system 100 creates artifacts and maintains within its data representation, links that track the “genealogy” or ancestry of its artifacts, at a finer level of granularity than the file level.

Specifically, the inventive system 100 may include a memory device for storing software for automatically tracking copies of data used in the document, and a processor for accessing the software for creating a record of copying of content, the record indicating from where the data was copied, and to where the data was copied. For example, the record may be stored in an ancestry tree data structure comprising a tree node which is a reference to content in a document, the tree node including a child link which indicates that a copy was made of the content from a content location referred to by the tree node, to a content location referred to by the child node.

For the purposes of the invention, the term “idea” is a representation in a computer of a piece of content. The inventive system 100 adds an ancestry tree to the native representation of data. This tree is automatically maintained by the native “copy” operations used in the system. When the “copy” operation is invoked on an object within the system, the data object is copied and then inserted as a child-node of the source-object's ancestry tree.

For instance, queries of the form: “Where are all of the places that this ‘idea’ was re-used?” can be facilitated in one of two ways. First, if the user wants, only ideas sourced from that idea can be retrieved by traversing (perhaps recursively) the ancestry sub-tree rooted at the given data element. If, on the other hand, the user wants all ideas that share a common progeny with the given idea, the system walks the ancestry tree back to its root and then traverses (perhaps recursively again) all of its children. Queries of the form “Where did this idea come from?” can be satisfied by traversing back to the top-level root node in the ancestry tree from the given data node.

When a group of objects is copied together (as in selecting a sentence in a word processor document and copying it) the inventive system 100 creates a container that transparently holds the multiple objects. This creates a representation of the “idea” (e.g., the set of objects which is copied together) and provides an object on which the bi-directional ancestry links can live.

The ancestry link is persistent (e.g., saved with the file format) and can cross document file boundaries, allowing tracking of ideas across multiple documents.

More specifically, noted briefly above, a composer often finds it useful to visualize relationships (e.g., between various materials within a composition) so that he can view the musical materials in relationship to some compositional process, and not only by the order in which they appear in the composition timeline.

For example, composers often use motifs—recurring thematic elements. In most tools, the composer can copy a motif from one place and re-use it in another with a “linking” operation. However, if, as often happens, the composer alters the motif in some particular context, the link—and, in most tools, the relationship—is broken. Of course, these elements are related in the composer's mind: they are instances of the same motif.

To address this problem, the representation (e.g., music representation) in the inventive system 100 provides “ancestry links” that point from the copy back to the original. When a musical fragment is copied and pasted, an ancestry link is created. The composer may adjust each motif instance to the surrounding musical context and the system retains this link, even if the music ultimately differs substantially. The composer can later query the system to see all recurrences of a given motif.

Thus, the inventive system 100 automates the process of tracking the usage of motivic materials in the system. The “Clone” operation on a music bundle, in fact, automatically creates and manages the “Ancestry” links. In other words, any Clone of a QSketcher bundle results in the creation of forward and backward “ancestry” links. This causes a directed acyclic graph (DAG) of usage tracking pointers to be created, and facilitates the navigation by way of these pointers to track the re-use of content through the work. These pointers are maintained in much the same manner as the traditional music containment hierarchy.

There are many other kinds of relationships that would be useful to establish, both episodic and semantic (functional). An episodic relationship associates an object with a certain concurrent or coincident activity. For example, a composer may not remember in what folder a certain melody patch is stored, but may be able to recall what scene of the film was showing when he first improvised it.

The scene is thus episodically related to the melody. A semantic or functional relationship connects objects that relate by a certain function, such as an expressive curve and a musical phrase, and its presence directly affects the final result. Containment relationships create a hierarchical structure, such as a violin melody within the string section in the second movement of the piece. A Process relationship indicates a sequence of actions that was used to shape musical material, such as a transposition, filtering, or inversion. Referential relationships indicate, e.g., the places where a musical entity is used, such as all the appearances of a given motive. In addition, the composer may want to create his own categorization relationships for grouping different objects together in a way the composer finds meaningful.

The above ideas impacted the design of the inventive system 100 in that the underlying music representation had to provide for establishing relationships without their being functional, and the user interface had to provide visualization and navigation facilities for managing them. (See, for example, the classic cognitive models of memory organization (Tulving, E., 1972, “Organization of Memory”, Academic Press) which first distinguished between episodic and semantic memory, and later the procedural memory as an additional class, along with propositional memory, which encompasses episodic and semantic memory (Tulving, E., 1983. “Elements of Episodic Memory”, Oxford University Press)). Note that for purposes herein, “episodic relationships” correspond to episodic memory, “process relationships” correspond to procedural memory, and other relationship categories all relate to semantic memory.

Referring again to FIG. 2, some relationships between the requirements of creativity and system components may be identified. It is important to note that in reality the relationships are more complex than indicated in FIG. 2. That is, most system components relate to more than one workflow stage or cognitive facet (Oppenheim, D. 1991. “Towards a Better Software-Design for Supporting Creative Musical Activity (CMA) ”, Proceedings of the ICMC, Montreal, Canada).

More specifically, in order to support tracking of motivic re-use in an arbitrary data structure, variables should be added to that data structure to support recording all data structures cloned from this data structure (hereafter referred to as offspring) and a variable capable of pointing to the data structure from which this data structure was cloned (hereafter referred to as the parent of the data structure). This arbitrary data structure can have can many offspring and only one parent.

Also associated with this arbitrary data structure is a “clone” operation. This is a function (or method in an object oriented language) that makes a copy of this arbitrary data structure. In the process of making this copy, the clone operation adds a pointer to the copy to the list of “offspring” associated with this data structure and a pointer to this data structure in the cloned copies pointer to its “parent”.

In a representative embodiment, this can be done using a “Bundle” data structure that contains a pointer to a vector (array) of offspring bundles and a pointer to its parent bundle. In this illustration the “Bundle” is the “arbitrary data structure” referred to in the above paragraph.

It may be helpful to provide some definitions of keywords used herein. Namely, the term “clone” is defined as “to make a copy of an object copying all clone-able attributes”. The term “bundle” is defined as “a data container of arbitrary contents”. And the term “offspring vector” is defined as “an array of Pointers to offspring bundles”.

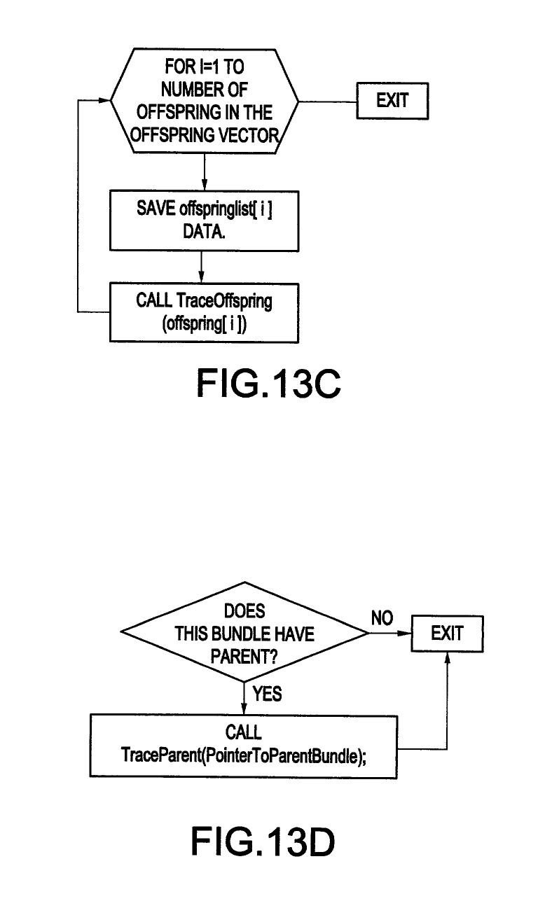

FIG. 13A illustrates the basic structure of a bundle and its cloned offspring. As shown in FIG. 13A, each time a Bundle is cloned a new pointer is added to the Offspring vector (owned by the parent bundle) links the parent bundle to its offspring. The parent bundle records this in a “Offspring Bundle Vector” and the Offspring Bundle maintains a pointer to this in its parent bundle. FIG. 13B is a flowchart illustrating the process of cloning of bundles.

To trace ancestry define two functions: TraceOffspring(PointerToBundle) and TraceParents(PointerToBundle). TraceOffspring(PointerToBundle) recursively traces all the offspring directly descended from the bundle pointed to by PointerToBundle. FIG. 13C is a flowchart illustrating how this function may be implemented

TraceParent(PointerToBundle) recursively traces the immediate parent bundle that this bundle (referenced by PointerToBundle) is descended from, as well as its grand parent, great grand parent etc.. FIG. 13D is a flowchart illustrating how this function may be implemented.

IV. Other Aspects

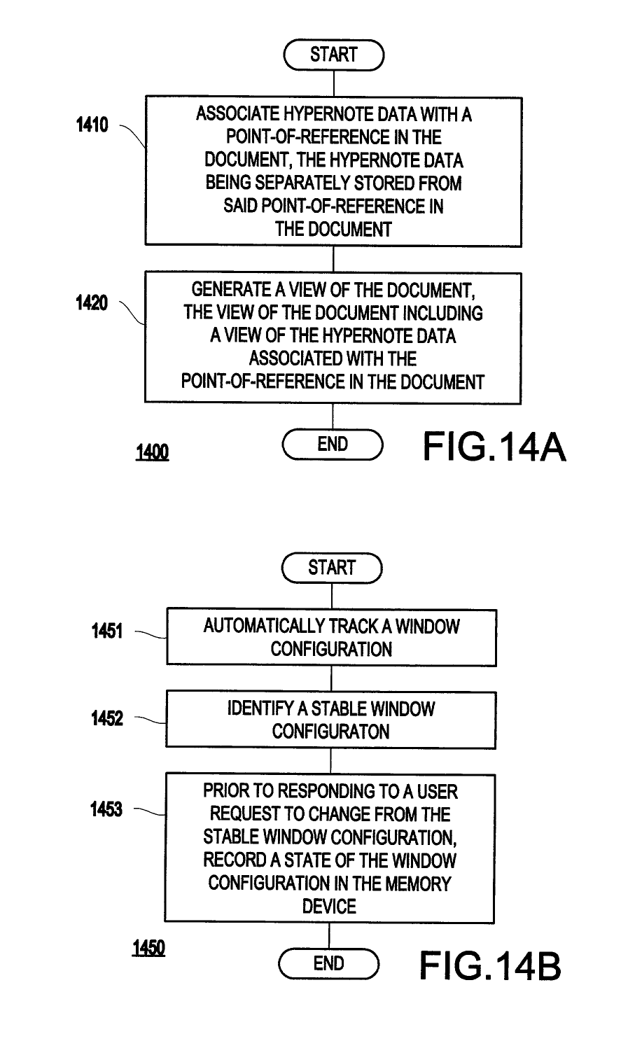

Referring now to FIG. 14A, the present invention also includes an inventive method 1400 for creating and editing a document. Generally, the inventive method 1400 may include associating (1410) hypernote data with a point-of-reference in the document, the hypernote data being separately stored from said point-of-reference in the document, and generating (1420) a view of the document, said view of the document comprising a view of the hypernote data associated with the point-of-reference in the document.

More specifically, the inventive method 1410 may be performed, in part, by a processor (e.g., computer) executing an inventive software as described above. For instance, as noted above, the inventive software may be stored in a memory device and used to manipulate objects and data. The processor may be used to access the inventive software and generate a view of the document including a view (e.g., a reference view) of data in the document, which may be displayed for the user on a display screen.

FIG. 14B shows an alternative inventive method 1450 which provides for saving and restoring view configurations to ensure that valuable ideas may be stored and recalled. The inventive method 1450 may include automatically tracking (1451) a window configuration, identifying (1452) a stable window configuration and, prior to responding to a user request to change from the stable window configuration, recording (1453) a state of the window configuration in the memory device.

FIG. 14C shows another alternative inventive method 1470 which provides for tracking of motivic re-use of data. The inventive method 1470 may include storing (1471) an ancestry tree data-structure wherein a tree node is a reference to content in a document, and a child link of a tree indicates that a copy was made of the content from a content location referred to by a parent node, to a content location referred to by a child node, and accessing (1472) the ancestry tree data-structure in order to automatically track a re-use of materials in the document.

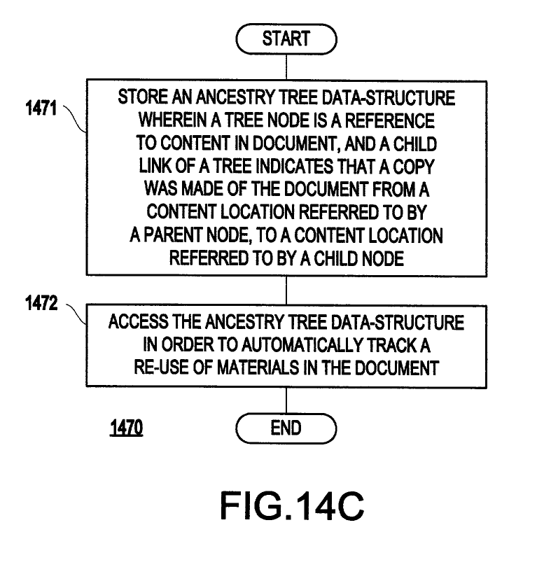

Referring now to FIG. 15, a typical hardware configuration 1500 is shown which may be used for implementing the inventive system 100 and method 1400. The configuration has preferably at least one processor or central processing unit (CPU) 1511. The CPUs 1511 are interconnected via a system bus 1512 to a random access memory (RAM) 1514, read-only memory (ROM) 1516, input/output (I/O) adapter 1518 (for connecting peripheral devices such as disk units 1521 and tape drives 1540 to the bus 1512), user interface adapter 1522 (for connecting a keyboard 1524, mouse 1526, speaker 1528, microphone 1532, and/or other user interface device to the bus 1512), a communication adapter 1534 for connecting an information handling system to a data processing network, the Internet, and Intranet, a personal area network (PAN), etc., and a display adapter 1536 for connecting the bus 1512 to a display device 1538 and/or printer 1539. Further, an automated reader/scanner 1541 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 1511 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 1511 and hardware above, to perform the method of the invention.

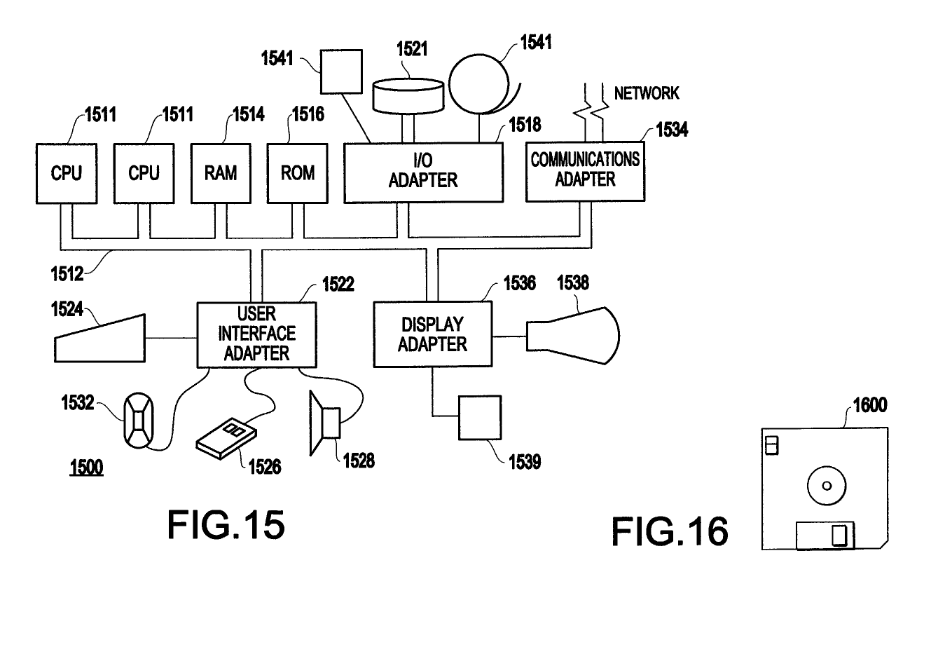

This signal-bearing media may include, for example, a RAM contained within the CPU 1511, as represented by the fast-access storage for example. Alternatively, the instructions may be contained in another signal-bearing media, such as a magnetic data storage diskette 1600 (FIG. 16), directly or indirectly accessible by the CPU 1511.

Whether contained in the computer server/CPU 1511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C”, “C++”, etc.

With its unique and novel features, the present invention provides better support for creative tasks, giving a user a tool that help track his workflow and allow him flexibility in what information he sees while working. Specifically, the present invention supports a compositional workflow by helping a user (e.g., music composer) to capture ideas, to organize those ideas to focus on the essential aspects, to manipulate those ideas in intuitive ways, and helping the user to keep track of his state-of-mind as he shifts from one activity to another.

While the invention has been described in terms of preferred embodiments, those skilled in the art will recognize that the invention can be practiced with modification within the spirit and scope of the appended claims. Specifically, although the present invention has been described herein at times with respect to musical composition, it should be understood that this is merely exemplary and that the present invention can be utilized in any situation where one document is being created or edited and quick and easy reference to other materials is helpful to the user.

What is claimed is:

1. A system for creating and editing a document, said system comprising:
a memory device for storing software for associating hypernote data with a point-of-reference in said document, said hypernote data being separately stored from said point-of-reference in said document; and
a processor for using said software to generate a view of said document, said view of said document comprising a view of said hypernote data associated with said point-of-reference in said document.

2. The system according to claim 1, wherein said view of said document further comprises a view of the document including said point-of-reference, and said hypernote data is visually related to said point-of-reference in said view of said document.

3. The system according to claim 1, wherein said view of said hypernote data is displayed in a read-only manner.

4. The system according to claim 1, wherein said view of said hypernote data comprises a pinned view which appears visually anchored to an anchor point in said document related to said point-of-reference, and said pinned view moves with said document as the user scrolls through said document.

5. The system according to claim 1, wherein said view of said hypernote data comprises a floating view which appears visually unanchored to said document and remains in a fixed location on the screen as a user scrolls through said document.

6. The system according to claim 1, wherein said hypernote data comprises data from a source external to said document.

7. The system according to claim 1, wherein said hypernote data comprises data from said document, said data having a source location in said document different from said point-of-reference.

8. A system for creating and editing a document, said system comprising:
a memory device for storing software for representing and displaying said document;
a processor for using said software to generate a view of said document; and
a display device for displaying said view of said document, said view of said document comprising a window to show data related to said document, said window comprising a visual characteristic which indicates a property of said data displayed in said window.

9. The system according to claim 8, wherein said visual characteristic comprises at least one of a beveled edge, a color, and a shadowed background.

10. The system according to claim 8, wherein said visual characteristic indicates that said data displayed in said window comprises hypernote data.

11. The system according to claim 8, wherein said visual characteristic indicates that said view of said document comprises a pinned view and a floating view.

12. The system according to claim 1, wherein said document comprises a musical composition.

13. The system according to claim 1, wherein said document comprises a word processing document.

14. The system according to claim 1, wherein said document comprises a picture document.

15. The system according to claim 1, wherein said document comprises a spreadsheet document.

16. The system according to claim 1, wherein said hypernote data comprises one of textual data, image data, musical data, tabular data, and hypertext markup language (HTML) data.

17. The system according to claim 1, wherein said hypernote data is implemented as a bundle which refers to other content.

18. A system for incorporating views of hypernote data in a document, said system comprising:
a means for representing a point-of-reference in said document;
a means for representing said hypernote data associated with said point-of-reference in said document; and
a means for identifying that said hypernote data is incorporated by reference and not included in said document at said point-of-reference.

19. The system according to claim 18, further comprising:
a means for displaying said hypernote data so as to visually identify it as hypernote data.

20. The system according to claim 18, further comprising:
a means for selectively ignoring hypernote data during final output preparation.

21. A method for creating and editing documents, comprising:
associating hypernote data with a point-of-reference in said document, said hypernote data being separately stored from said point-of-reference in said document; and
generating a view of said document, said view of said document comprising a view of said hypernote data associated with said point-of-reference in said document.

22. A programmable storage medium tangibly embodying a program of machine-readable instructions executable by a digital processing apparatus to perform a method for creating and editing documents, said method comprising:
associating hypernote data with a point-of-reference in said document, said hypernote data being separately stored from said point-of-reference in said document; and
generating a view of said document, said view of said document comprising a view of said hypernote data associated with said point-of-reference in said document.

23. A system for creating and editing documents comprising:
a memory device for storing software for automatically tracking a window configuration; and
a processor accessing said software, for identifying a stable window configuration and, prior to responding to a user request to change from said stable window configuration, recording a state of said window configuration in said memory device.

24. A method for creating and editing documents comprising:
automatically tracking a window configuration;
identifying a stable window configuration; and
prior to responding to a user request to change from said stable window configuration, recording a state of said window configuration in said memory device.

25. A programmable storage medium tangibly embodying a program of machine-readable instructions executable by a digital processing apparatus to perform a method for creating and editing documents, said method comprising:
automatically tracking a window configuration;
identifying a stable window configuration; and
prior to responding to a user request to change from said stable window configuration, recording a state of said window configuration in said memory device.

26. A system for creating and editing documents comprising:
a memory device for storing software for automatically tracking window configurations;
a processor accessing said software, for identifying a relevant window event, determining if a predetermined time has elapsed before a next relevant window event and, if so, recording the state of said window configuration in said memory device.

27. A method for creating and editing documents comprising:
automatically tracking a window configuration;
identifying a relevant window event; and
determining if a predetermined time has elapsed before a next relevant window event and, if so, recording a state of said window configuration.

28. A programmable storage medium tangibly embodying a program of machine-readable instructions executable by a digital processing apparatus to perform a method for creating and editing documents, said method comprising:
automatically tracking a window configuration;
identifying a relevant window event; and
determining if a predetermined time has elapsed before a next relevant window event and, if so, recording a state of said window configuration.

29. A system for creating and editing documents comprising:
a display screen for displaying a workspace configuration log which comprises at least one window configuration, each window configuration shown as a graphical image, each graphical image being associated with a set of data structures containing data necessary to restore a window configuration;
a selector for allowing a user to select a window configuration; and
a processor for obtaining a set of data structures associated with a selected window configuration, and restoring said selected window configuration on said display device.

30. The system according to claim 29, wherein said graphical image is a reduced scale image of said display screen.

31. A method for creating and editing documents comprising:
displaying at least one window configuration, each window configuration shown as a graphical image, each graphical image being associated with a set of data structures containing data necessary to restore a window configuration;
selecting a window configuration;
obtaining a set of data structures associated with a selected window configuration; and
restoring said selected window configuration.

32. A programmable storage medium tangibly embodying a program of machine-readable instructions executable by a digital processing apparatus to perform a method for creating and editing documents, said method comprising:
displaying at least one window configuration, each window configuration shown as a graphical image, each graphical image being associated with a set of data structures containing data necessary to restore a window configuration;
selecting a window configuration;
obtaining a set of data structures associated with a selected window configuration; and
restoring said selected window configuration.

33. A system for creating and editing documents comprising:
a memory device for storing software for automatically tracking copies of data used in said document; and
a processor for accessing said software for creating a record of copying of content, said record indicating from where said data was copied, and to where said data was copied.

34. The system according to claim 33, wherein said record is stored in an ancestry tree data structure comprising a tree node which is a reference to content in a document, said tree node comprising a child link which indicates that a copy was made of said content from a content location referred to by said tree node, to a content location referred to by said child node.

35. The system for according to claim 33, wherein said processor automatically maintains said ancestry tree data structure whenever content is selected and copied.

36. The system according to claim 34, further comprising:
a display device for displaying, in a graphical form, links of an ancestry tree superimposed over an overview of said document.

37. The system according to claim 34, wherein said data comprises musical fragments and said document comprises a musical composition.

38. The system according to claim 34, wherein said data comprises textual content and said document comprises a text document.

39. A method for creating and editing documents comprising:
automatically tracking copies of data used in said document; and
creating a record of copying of content, said record indicating from where said data was copied, and to where said data was copied.

40. A programmable storage medium tangibly embodying a program of machine-readable instructions executable by a digital processing apparatus to perform a method for creating and editing documents, said method comprising:
automatically tracking copies of data used in said document; and
creating a record of copying of content, said record indicating from where said data was copied, and to where said data was copied.

41. A method for creating and editing documents comprising:
storing an ancestry tree data-structure wherein a tree node is a reference to content in a document, and a child link of a tree indicates that a copy was made of said content from a content location referred to by a parent node, to a content location referred to by a child node; and
accessing said ancestry tree data-structure in order to automatically track a re-use of materials in said document.

42. A programmable storage medium tangibly embodying a program of machine-readable instructions executable by a digital processing apparatus to perform a method for creating and editing documents, said method comprising:
storing an ancestry tree data-structure wherein a tree node is a reference to content in a document, and a child link of a tree indicates that a copy was made of said content from a content location referred to by a parent node, to a content location referred to by a child node; and
accessing said ancestry tree data-structure in order to automatically track a re-use of materials in said document.

43. A system for creating and editing documents, comprising:
an input device;
a monitoring system for monitoring said input device and capturing input presented to peripherals, without requiring a user instruction.

44. The system according to claim 43, further comprising:
an annotation device for annotating captured input with contextual information about a system state at a time of capture, said information comprising one of calendar date, wall-clock time, and current scroll position in the document.

45. The system according to claim 43, further comprising:
a storage facility for storing said captured data.

46. The system according to claim 43, further comprising:
a search mechanism for retrieving captured data based on a property of a system state at a time that said input was captured.

47. The system according to claim 46, wherein said property comprises one of a time/date captured, and a current document position when captured.
